(19) United States
(12) Patent Application Publication
(10) Pub. No.: US 2024/0236800 A9
(43) Pub. Date: Jul. 11, 2024

(54) Mobility Failure Classification based on MCG Failure Information

(71) Applicant: Telefonaktiebolaget LM Ericsson (publ), Stockholm (SE)

(72) Inventors: Ali Parichehrehteroujeni, Linköping (SE); Pradeepa Ramachandra, Linköping (SE); Marco Belleschi, Solna (SE)

(21) Appl. No.: 18/546,282

(22) PCT Filed: Mar. 10, 2022
(86) PCT No.: PCT/SE2022/050238

§ 371 Date: Aug. 14, 2023

Related U.S. Application Data
(60) Provisional application No. 63/160,144, filed on Mar. 12, 2021.

(51) Int. Cl. H04W 36/30; H04W 36/00; H04W 76/19

(52) U.S. Cl. CPC H04W 36/305; H04W 36/0079; H04W 76/19

(57) ABSTRACT

Methods and apparatuses for classifying mobility failure. A method performed by a wireless device comprises detecting a failure event in a MCG, wherein the failure event is at least one of a RLF and a HOF. The method further comprises logging MCG Failure Information associated with the failure event subsequent to detection of the failure event, wherein the MCG Failure Information comprises an elapsed time between time of reception of a last RRC reconfiguration message associated with the MCG and time of MCG connection failure. The RRC reconfiguration message including reconfiguration with sync.

### TECHNICAL FIELD

Embodiments of the present disclosure relate to methods, wireless devices and base stations, and particularly methods, wireless devices and base stations for classifying mobility failure.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

5G Architecture

The current 5G RAN (NG-RAN) architecture is depicted and described in TS 38.401 v 15.7.0; the overall architecture is shown in FIG. 1.

The NG-RAN architecture can be further described as follows. The NG-RAN consists of a set of gNBs connected to the 5GC through the NG. An gNB can support FDD mode, TDD mode or dual mode operation. gNBs can be interconnected through the Xn interface. A gNB may consist of a gNB-CU and gNB-DUs. A gNB-CU and a gNB-DU are connected via F1 logical interface. One gNB-DU is connected to only one gNB-CU. For resiliency, a gNB-DU may be connected to multiple gNB-CU by appropriate implementation. NG, Xn and F1 are logical interfaces. The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signalling transport.

Another architectural option is that where an LTE eNB connected to the Evolved Packet Core network is connected over the X2 interface with a so called nr-gNB. The latter is a gNB not connected directly to a CN and connected via X2 to an eNB for the sole purpose of performing dual connectivity.

The architecture in FIG. 1 can be expanded by spitting the gNB-CU into two entities. One gNB-CU-UP, which serves the user plane and hosts the PDCP protocol and one gNB-CU-CP, which serves the control plane and hosts the PDCP and RRC protocol. For completeness it should be said that a gNB-DU hosts the RLC/MAC/PHY protocols.

Mobility Robustness Organization (MRO) and Radio Link Failure (RLF) in LTE/NR

Seamless handovers are a key feature of 3GPP technologies. Successful handovers ensure that the UE moves around in the coverage area of different cells without causing too much interruptions in the data transmission. However, there will be scenarios when the network fails to handover the UE to the ‘correct’ neighbour cell in time and in such scenarios the UE will declare the radio link failure (RLF) or Handover Failure (HOF).

Upon HOF and RLF, the UE may take autonomous actions i.e. trying to select a cell and initiate reestablishment procedure so that we make sure the UE is trying to get back as soon as it can, so that it can be reachable again. The RLF will cause a poor user experience as the RLF is declared by the UE only when it realizes that there is no reliable communication channel (radio link) available between itself and the network. Also, reestablishing the connection requires signaling with the newly selected cell (random access procedure, RRC Reestablishment Request, RRC Reestablishment RRC Reestablishment Complete, RRC Reconfiguration and RRC Reconfiguration Complete) and adds some latency, until the UE can exchange data with the network again.

According to the LTE/NR specifications (TS 36.331 v 16.3.0 available at https://porta1.3gpp.org/desktopmodules/Specifications/SpecificationDetails.aspx?specificationId=2440 as of 12 Jan. 2022, and TS 38.331 v 16.3.1 available at https://portal.3gpp.org/desktopmodules/Specifications/SpecificationDetails.aspx?specificationId=3197 as of 12 Jan. 2022), the possible causes for the radio link failure could be one of the following:
1) Expiry of the radio link monitoring related timer T310;
2) Expiry of the measurement reporting associated timer T312 (not receiving the handover command from the network within this timers duration despite sending the measurement report when T310 was running);
3) Upon reaching the maximum number of RLC retransmissions for the MCG;
4) Upon receiving random access problem indication from the MCG MAC entity;

As RLF leads to reestablishment which degrades performance and user experience, it is in the interest of the network to understand the reasons for RLF and try to optimize mobility related parameters (e.g. trigger conditions of measurement reports) to avoid later RLFs. Before the standardization of MRO related report handling in the network, only the UE was aware of some information associated to how did the radio quality looked like at the time of RLF, what is the actual reason for declaring RLF etc. For the network to identify the reason for the RLF, the network needs more information, both from the UE and also from the neighbouring base stations.

As part of the MRO solution in LTE, the RLF reporting procedure was introduced in the RRC specification in Rel-9 RAN2 work. That has impacted the RRC specifications (TS 36.331, as cited above) in the sense that it was standardized that the UE would log relevant information at the moment of an RLF and later report to a target cell the UE succeeds to connect (e.g. after reestablishment). That has also impacted the inter-gNodeB interface, i.e., X2AP specifications (TS 36.423 v 16.4.0, available at https://portal.3gpp.org/desktopmodules/Specifications/SpecificationDetails.aspx?specificationId=2452 as of 12 Jan. 2022), as an eNodeB receiving an RLF report could forward to the eNodeB where the failure has been originated.

In LTE/NR, lower layers provide to upper layer Out-of-Sync (OOS) and In-Sync (IS), internally by the UE's physical layer, which in turn may apply RRC/layer 3 (i.e. higher layer) filtering for the evaluation of Radio Link Failure (RLF). The procedure is illustrated in FIG. 2.

For the RLF report generated by the UE, its contents have been enhanced with more details in the subsequent releases. The measurements included in the measurement report based on the latest LTE RRC specification (TS 36.331 v16.3.0, as cited above) are:
1) Measurement quantities (RSRP, RSRQ) of the last serving cell (PCell).
2) Measurement quantities of the neighbour cells in different frequencies of different RATs (EUTRA, UTRA, GERAN, CDMA2000).
3) Measurement quantity (RSSI) associated to WLAN Aps.
4) Measurement quantity (RSSI) associated to Bluetooth beacons.
5) Location information, if available (including location coordinates and velocity)
6) Globally unique identity of the last serving cell, if available, otherwise the PCI and the carrier frequency of the last serving cell.
7) Tracking area code of the PCell.
8) Time elapsed since the last reception of the ‘Handover command’ message.
9) C-RNTI used in the previous serving cell.
10) Whether or not the UE was configured with a DRB having QCI value of 1.

The detection and logging of the RLF related parameters are captured in section 5.3.11.3 of LTE RRC specification (TS 36.331 v16.3.0).

After the RLF is declared, the RLF report is logged and, once the UE selects a cell and succeeds with a reestablishment, it includes an indication that it has an RLF report available in the RRC Reestablishment Complete message, to make the target cell aware of that availability. Then, upon receiving an UEInformationRequest message with a flag “rlf-ReportReq-r9” the UE shall include the RLF report (stored in a UE variable VarRLF-Report, as described above) in an UEInformationResponse message and send to the network.

The UEInformationRequest, and UEInformationResponse messages are captured in sections 6.2.2 and 5.6.5.3 of LTE RRC specification (TS 36.331 v16.3.0).

Based on the contents of the RLF report (e.g. the Globally unique identity of the last serving cell, where the failure was originated), the cell in which the UE reestablishes can forward the RLF report to the last serving cell. This forwarding of the RLF report is done to aid the original serving cell with tuning of the handover related parameters (e.g. measurement report triggering thresholds) as the original serving cell was the one who had configured the parameters associated to the UE that led to the RLF.

Two different types of inter-node messages have been standardized in LTE for that purpose, the Radio link failure indication and the handover report (in TS 36.423 v16.4.0).

The Radio link failure indication procedure is used to transfer information regarding RRC re-establishment attempts or received RLF reports between eNBs. This message is sent from the eNB in which the UE performs reestablishment to the eNB which was the previous serving cell of the UE.

MCG Fast Recovery Procedure

Rel-15 saw the introduction of several Dual Connectivity (DC) options including New Radio (NR) access. In DC, the user equipment (UE) is connected simultaneously to a Master Node (MN) and a Secondary Node (SN). The UE can be configured to operate in carrier aggregation (CA) with each node. The cells of the MN where the UE is operating in CA are referred to as the master cell group (MCG), while those of the SN are referred to as the secondary cell group (SCG).

The fast MCG link recovery feature introduced later in Rel-16 aims to decrease the connection interruption time during radio link failure (RLF). By utilizing the SCG connectivity, the interruption time caused by MCG RLF can be reduced from several seconds down to a typical handover interruption time of 30-70 ms. For end users, this directly translates into decreased service interruption times.

The different DC options available since Rel-15 are collectively referred to as Multi-Radio Dual Connectivity (MR-DC), and can be one of these (see FIG. 3):
EN-DC: the MN is an LTE, or E-UTRA, node and the SN is an NR node. The UE is connected to the 4G Evolved Packet Core (EPC). This option was introduced in the early drop of Rel-15 as a first step towards 5G deployments.
NGEN-DC: same as EN-DC, but the UE is connected to the 5G core (5GC)
NE-DC: the MN is an NR node and the SN is a E-UTRA node. The UE is connected to 5GC
NR-DC: both the MN and the SN are NR nodes and the UE is connected to the 5GC MR-DC options

To improve signaling robustness, in all MR-DC options, the UE may be configured with a split Signaling Radio Bearer (SRB), which enables transmission of Radio Resource Control (RRC) signaling via the MCG and/or SCG. That is, E-UTRA or NR RRC messages such as RRC Reconfiguration can be sent using the MN and/or SN radio resources. Additionally, in EN-DC, NGEN-DC and NR-DC, the UE may be configured with SRB3, which is an SRB terminated in the SN and used only for control signaling between the SN and UE (meaning where no coordination with the MN is required). Split SRB and SRB3 are illustrated in FIG. 4.

In NR or LTE standalone operation, a UE detecting loss of downlink synchronization (physical layer problem), maximum random access attempts (random access problem) or maximum number of RLC retransmissions will declare RLF and trigger the RRC re-establishment procedure. Details about this can be found in the 3GPP documents TS 36.331 and TS 38.331 (as cited above).

This procedure involves suspending all current transmissions, scanning for the best neighbouring cell on the same or neighbouring frequency (cell reselection) and triggering the RRC re-establishment procedure in the detected best cell. In total, this causes an outage lasting typically a few seconds before the UE is resynchronized again with the network, connectivity is restored, and data transmission is resumed.

In LTE-DC, if the UE encounters a failure towards the SCG, it does not trigger the re-establishment procedure, as the connection to the MN could be working perfectly. The feature builds on the principle that as long as there is connectivity between the network and the UE, in this case via the MCG, it is best to maintain the network control over how the situation is resolved. So, the UE initiates an SCG failure recovery procedure, also referred to as SCG Failure Information, where the UE sends a report to the MN indicating that the SCG has failed, the reason for the failure and any available measurements. The MN can then use this information to release, reconfigure or change the SN.

The SCG failure recovery procedure was adopted in Rel-15 for all MR-DC options. However, in Rel-15, problems in the MCG still lead to the UE triggering the re-establishment procedure, even when the SCG is still working. This is unnecessary, as there is still connectivity between the SN and the UE. Following the same principle of network control as applied for the SCG failure information procedure, we at Ericsson have, since early Rel-15 discussions, been driving the introduction of fast MCG link recovery, see for example, R2-1702711 and R2-1901413, to improve robustness against RLF in MR-DC. This was not agreed for Rel-15, but for Rel-16, a work item on CA&DC enhancements was agreed, in which network-controlled recovery from MCG failure is one of the objectives.

Further motivation for introducing a fast MCG link recovery procedure is given by the multiple deployments that are enabled when using different ranges of frequencies (from 700 MHz up to 52.6 GHz) over the MCG and SCG. This means that when the frequency deployed in the MCG is higher than the one deployed in the SCG, the probability of problems in the MCG increases, while the SCG may be more stable.

Fast MCG link recovery is supported for UEs in MR-DC configured with either split SRB or SRB3. A prerequisite for the fast MCG link recovery is that the SCG is not suspended, so that it can be used for the MCG failure reporting.

A UE in MR-DC does not trigger RRC re-establishment upon detecting an RLF. Instead, it suspends the MCG transmissions of all bearers and prepares an MCGFailureInformation message, containing the reason for failure and any available measurements at the time of failure, in order to help the network take the appropriate action. The UE then sends the MCGFailureInformation message to the network via the SCG, using the SCG radio resources either in split SRB1 or SRB3. If both split SRB1 and SRB3 are configured, the UE sends the message via split SRB1. In case the message is sent via SRB3, instead, the SN will forward the MCGFailureInformation message to the MN via internode interface between the MN and SN. Upon sending the MCGFailureInformation, the UE triggers a T316 timer, that is stopped upon receiving RRCRelease, RRCReconfiguration with reconfigurationwithSync for the PCell, MobilityFromNRCommand. Otherwise, when the T316 expires, and none of the above messages have been received, the UE triggers an RRC reestablishment procedure.

Upon receiving the MCGFailureInformation message from the UE, the MN determines the best action to address the MCG failure based on, for example, the measurement information received from the UE. The action may typically be a reconfiguration to change the Primary Cell of the UE to a better cell to restore the MCG connectivity.

Alternatively, if no suitable target cell is determined, the network may send an RRC release message to the UE to release the connection. In case split SRB1 is used, the network response is directly sent to the UE, by using the SCG leg of the split SRB—see FIG. 5. For the SRB3 case, the MN sends the response message to the SN, which then encapsulates it inside an SN RRC message and sends it to the UE.

The main benefit of the MCG failure recovery procedure, also known as “fast MCG link recovery” is that the rather long interruption during MCG RLF detection and subsequent cell reselection and RRC re-establishment can be avoided. Depending on the UE configuration, carrier frequency and network deployment, this can take up to seconds. Instead, UE connectivity can be maintained via the SCG during the time the MCG is restored and typically only a short interruption—comparable to a normal handover interruption (30-70 ms)—is experienced, while the network prepares and sends the proper response message to reconfigure the UE. Note that this is the physical layer interruption and that the IP level interruption may be longer, depending on the link layer protocols; PDCP, RLC and MAC.

In contrast to the UE controlled RRC re-establishment procedure, the network remains in control during MCG failure recovery, as long as SCG connectivity is still there. The network can select the most appropriate action/reconfiguration, based on UE provided measurement information as well as considering the network's overall situation like network load, subscription and service information (for example QoS of active bearers of the UE).

UE History Information

According to the 3GPP TS 38.423 v16.4.0, The UE History Information IE contains information about cells that a UE has been served by in active state prior to the target cell.

NOTE: The definition of this IE is aligned with the definition of the UE History Information IE in TS 38.413 (v 16.4.0 available at https://porta1.3gpp.org/desktopmodules/Specifications/SpecificationDetails. aspx?specificationId=3223 as of 12 Jan. 2022).

| | | | IE Type and | Semantics |
|---|---|---|---|---|
| IE/Group Name | Presence | Range | Reference | Description |
| Last Visited Cell List | | 1..<maxnoofCellsin | | Most recent |
| | | UEHistoryInfo> | | information is added |
| | | | | to the top of this list |
| >Last Visited Cell | M | | 9.2.3.65 | |
| Information | | | | |

| Range bound | Explanation |
|---|---|
| maxnoofCellsinUEHistoryInfo | Maximum number of last visited cell information records that can be |
| | reported in the IE. Value is 16. |

There currently exist certain challenge(s). As discussed above, in LTE/NR rel-16, the MCG fast recovery procedure is being specified, where instead of initiating a re-establishment procedure, the UE sends an MCG failure information report to the MN using the SCG leg of split SRB1 or SRB3. However currently there is no mechanism at the network side to classify the failure types based on the MCG Failure Information. Upon RLF in the MCG or handover failure from the PCell of the MCG to another cell, the UE stores parameters associated to this failure in the RLF-Report. However, if after the MCG failure recovery, i.e. after transmitting the MCG Failure Information, the UE receives an RRCReconfiguration with sync from the network to handover the UE to another PCell, or the UE receives an RRC Release, the UE deletes the previously stored RLF-Report. Hence, if the MCG failure recovery procedure is successful (as in the case just mentioned), the network will not receive any information associated to the experienced RLF/HOF.

In other words, when the network node receives MCG failure information there is no means to identify whether the failure was due to a Too Late Handover (HO), or Too Early HO or a HO toward a wrong cell, since the MCG Failure Information message does not contain any information that allows the network to categorize such HO as “too late”/“too early”/“to wrong cell”, and the RLF-Report that may contain such information is deleted when the UE is reconfigured to another PCell or it is released, i.e. the MCG failure recovery is successful. Hence it is not possible to take any counter action to resolve the failures in the future. Same problem exists when a CHO is configured for the UE. Therefore, based on the current state-of-the-art it is not possible for the network nodes to optimize the handover parameters based on the MCG Failure Information.

Currently, UE, as part of the MCG Failure Information message, does not provide the time elapsed since the reception or the execution of the last RRC message including a reconfiguration with sync. Hence it is not possible to distinguish the failure types (Too Early HO, Too Late HO, etc.) solely on the basis of the MCG Failure Information.

Certain aspects of the present disclosure and their embodiments may provide solutions to these or other challenges.

### SUMMARY

It is an object of the present disclosure to provide methods executed by a network node such as a gNB, gNB-CU, eNB, to classify the HO failure type based on the MCG Failure Information and additional information such as UE history information. In more detail, different methods are proposed in the present disclosure:

The network node classifies the failure upon receiving an MCG failure information as a Too Late HO, if the measurements provided by the MCG Failure Information reveal that there was a better cell than the source cell at the time of the MCG failure, and if the UE history information indicates UE was dwelling/visiting for a long enough time at the serving PCell before the MCG Failure.

In another embodiment, the network node observes from the MCGFailureInformation that T310 expiry is the reason of failure, but no measurement was available, and the network node sends RRC reconfiguration with sync to the UE (e.g., sending the UE to the LTE network). Hence, the network node concludes that the failure is caused due to a Too Late HO.

The network node classifies the failure upon receiving an MCG failure information as a Too Early HO, if the measurements provided by the MCG Failure Information reveal that the source cell was a better cell than the neighbouring cells at the time of the MCG failure, and if the UE history information indicates UE was not dwelling/visiting for long time at the serving PCell before the MCG Failure.

The network node classifies the failure upon receiving an MCG failure information as a HO to wrong cell, if the measurements provided by the MCG Failure Information reveal that there was a better cell than the source cell and the target cell of the HO among the neighbouring cells, at the time of the MCG failure, and if the UE history information indicates UE was not dwelling/visiting for long time at the serving PCell before the MCG Failure.

According to embodiments of the present disclosure, there are provided methods executed by a wireless terminal (so-called User Equipment) to log additional information as part of MCG Failure Information or as part of the RLF report to indicate the outcome of the MCG Failure recovery procedure.

Methods, apparatuses, and systems proposed in the present disclosure enable the RAN nodes to detect and classify the mobility failure types based on the MCG Failure information reported by the UEs.

There are, proposed herein, various embodiments which address one or more of the issues disclosed herein.

According to certain embodiments, there is provided a method performed by a wireless device. The method comprises: detecting a failure event in a Master Cell Group (MCG), wherein the failure event is at least one of a Radio Link Failure (RLF) and a Handover Failure (HOF), and logging Master Cell Group (MCG) Failure Information associated with the failure event subsequent to detection of the failure event, wherein the MCG Failure Information comprises an elapsed time between time of reception of a last Radio Resource Control (RRC) reconfiguration message associated with the MCG and time of MCG connection failure, the RRC reconfiguration message including reconfiguration with sync.

In some embodiments, the method may further comprise transmitting the MCG Failure Information to a base station.

In some embodiments, the MCG Failure Information may further comprise an elapsed time between time of successful execution of the last RRC reconfiguration message associated with the MCG and time of MCG connection failure, the RRC reconfiguration message including reconfiguration with sync.

In some embodiments, the method may further comprise: logging additional information in a Radio Link Failure (RLF) report after a fast MCG link recovery procedure, the additional information indicating an outcome of a fast MCG link recovery procedure, and transmitting the RLF report to the base station.

In some embodiments, the additional information may comprise an indication of whether the wireless device was configured for fast MCG link recovery procedure at the time of the detection of the Radio Link Failure (RLF) event.

In some embodiments, the additional information may comprise an indication that the wireless device performed a fast MCG link recovery procedure and the fast MCG link recovery procedure failed. In these embodiments, the additional information may further comprise at least one of:
cell ID of the cell in which the wireless device attempted reestablishment after T316 expiry,
an indication of whether the cell in which the wireless device attempted reestablishment after T316 expiry was in a list of Conditional Handover (CHO) candidate cells,
an elapsed time between time of the failure event in the MCG and time of reestablishment in a cell after T316 expiry, or an elapsed time between time of execution of the handover that resulted in the Handover Failure (HOF) event and time of establishment in a cell after T316 expiry,
an elapsed time between time of the failure event in the MCG and time of the wireless device entering an idle mode due to no suitable cell found after T316 expiry and possible failure of reestablishment in another cell, and
an indication of T316 expiry.

In some embodiments, the additional information may comprise an indication that the wireless device had a Conditional Handover (CHO) configuration at the time of the detection of the Radio Link Failure (RLF) or the Handover Failure (HOF).

In some embodiments, the additional information may comprise an indication that the wireless device performed a fast MCG link recovery procedure, and that the fast MCG link recovery procedure succeeded. In these embodiments, the additional information may further comprise at least one of:
cell ID of the cell in which the handover (HO) was executed,
an indication of whether the executed handover was in response to a received HO command or in response of a CHO configuration,
an indication of whether the executed handover was successful or not
cell ID of the cell in which the wireless device attempted reestablishment if the executed handover was not successful,
an indication that no suitable cell was found upon failure of the handover towards a target cell and possible failure of reestablishment attempt,
an elapsed time between time of the failure event in the MCG and time of the HO execution before T316 expiry, or an elapsed time between time of execution of the handover that resulted in the HOF event and time of the HO execution before T316 expiry,
an elapsed time between time of the failure event in the MCG and a point in time at which the HO execution is declared successful or completed, or an elapsed time between time of execution of the handover that resulted in the HOF event and a point in time at which the HO execution is declared successful or completed,
an elapsed time between time of the failure event in the MCG and a point in time at which the HO execution is declared unsuccessful, or an elapsed time between time of execution of the handover that resulted in the HOF event and a point in time at which the HO execution is declared unsuccessful,
an elapsed time between time of the failure event in the MCG and time of successful reestablishment after unsuccessful HO execution, or an elapsed time between time of execution of the handover that resulted in the HOF event and time of successful reestablishment after unsuccessful HO execution, and
an elapsed time between time of the failure event in the MCG and time of the wireless device entering an idle mode after unsuccessful reestablishment and unsuccessful HO execution.

In some embodiments, the method may further comprise performing at least one of:
determining that the fast MCG link recovery procedure has failed if T316 expired before the wireless device receives a handover (HO) command or if before the wireless device executes a previously configured CHO configuration; and
determining that the fast MCG link recovery procedure has succeeded if the wireless device has executed handover towards a Primary Cell (PCell), or if the wireless device received a RRC release message before T316 expiry.

In some embodiments, the method may further comprise maintaining the RLF report after handover execution.

In some embodiments, the method may further comprise transmitting wireless device history information of the wireless device to the network node.

According to certain embodiments, there is provided a method performed by a base station for classifying mobility failure. The method comprises receiving, from a wireless device, at least one of: Master Cell Group (MCG) Failure Information and a Radio Link Failure (RLF) report, the MCG Failure Information and/or the RLF report being associated with a failure event, and the failure event being at least one of: a Radio Link Failure (RLF) and a Handover Failure (HOF), and classifying the failure event based on the MCG Failure Information and/or the RLF report.

In some embodiments, classifying the failure event may be based on:
comparison between a radio link quality at the time of the failure event of at least one of: a source cell associated with the failure event and a target cell associated with the failure event and radio link quality of one or more neighbouring cells at the time of the failure event, and
a duration in which the wireless device was dwelling or visiting at a last serving cell before the failure event.

In some embodiments, classifying the failure event may comprise classifying the failure event as one of: late handover, early handover, handover to wrong cell, late conditional handover, early conditional handover, and conditional handover to wrong cell.

In some embodiments, the MCG Failure Information may comprise an elapsed time between time of reception of a last RRC reconfiguration message associated with the MCG and time of MCG connection failure, the Radio Resource Control (RRC) reconfiguration message including reconfiguration with sync.

In some embodiments, the MCG Failure Information may comprise an elapsed time between time of successful execution of the last RRC reconfiguration message associated with the MCG and time of MCG connection failure, the RRC reconfiguration message including reconfiguration with sync.

In some embodiments, classifying the failure event may comprise:
determining, based on the MCG Failure Information and/or the RLF report, whether at the time of the failure event among neighbouring cells there was a cell with higher radio link quality than that of the source cell associated with the failure event;
determining whether a duration in which the wireless device was dwelling or visiting at a last serving cell before the failure event exceeds a predetermined threshold; and
classifying the failure event as a late handover, if it is determined that at the time of the failure event there was a cell with higher radio link quality than that of the source cell associated with the failure event, and that the duration in which the wireless device was dwelling or visiting at a last serving cell before the failure event exceeds the predetermined threshold.

In some embodiments, classifying the failure event may comprise:
determining, based on the MCG Failure Information and/or the RLF report, whether at the time of the failure event among neighbouring cells there was a cell with higher radio link quality than that of the source cell associated with the failure event;
determining whether a duration in which the wireless device was dwelling or visiting at a last serving cell before the failure event exceeds a predetermined threshold; and
determining whether there is an existing Conditional Handover (CHO) configuration for the wireless device; and
classifying the failure event as a late conditional handover, if it is determined that at the time of the failure event there was a cell with higher radio link quality than that of the source cell associated with the failure event, that the duration in which the wireless device was dwelling or visiting at a last serving cell before the failure event exceeds the predetermined threshold, and that there is an existing CHO configuration for the wireless device.

In some embodiments, classifying the failure event may comprise:
determining, based on the MCG Failure Information and/or the RLF report, whether at the time of the failure event the source cell associated with the failure event had higher radio link quality than that of the target cell associated with the failure event and radio link qualities of neighbouring cells;
determining whether a duration in which the wireless device was dwelling or visiting at a last serving cell before the failure event exceeds a predetermined threshold; and
classifying the failure event as early handover, if it is determined that at the time of the failure event the source cell associated with the failure event had higher radio link quality than that of the target cell associated with the failure event and radio link qualities of neighbouring cells, and that the duration in which the wireless device was dwelling or visiting at a last serving cell before the failure event does not exceed the predetermined threshold.

In some embodiments, classifying the failure event may comprise:
determining, based on the MCG Failure Information and/or the RLF report, whether at the time of the failure event the source cell associated with the failure event had higher radio link quality than the of the target cell associated with the failure event and radio link qualities of neighbouring cells;
determining whether a duration in which the wireless device was dwelling or visiting at a last serving cell before the failure event exceeds a predetermined threshold;
determining whether there is an existing Conditional Handover (CHO) configuration for the wireless device; and
classifying the failure event as early conditional handover, if it is determined that at the time of the failure event the source cell associated with the failure event had higher radio link quality than that of the target cell associated with the failure event and radio link qualities of neighbouring cells, that the duration in which the wireless device was dwelling or visiting at a last serving cell before the failure event does not exceed the predetermined threshold, and that there is an existing CHO configuration for the wireless device.

In some embodiments, classifying the failure event may comprise:
determining, based on the MCG Failure Information and/or the RLF report, whether at the time of the failure event among neighbouring cells there was a cell with higher radio link quality than those of the source cell and the target cell associated with the failure event, and whether the cell with higher radio link quality is different from cells configured as part of Secondary Cell Group;
determining whether a duration in which the wireless device was dwelling or visiting at a last serving cell before the failure event exceeds a predetermined threshold; and
classifying the failure event as handover to a wrong cell, if it is determined that at the time of the failure event there was a cell with higher radio link quality than those of the source cell and the target cell associated with the failure event, that the cell with higher link quality is different from cells configured as part of Secondary Cell Group, and that the duration in which the wireless device was dwelling or visiting at a last serving cell before the failure event does not exceed the predetermined threshold.

In some embodiments, classifying the failure event may comprise:
determining, based on the MCG Failure Information and/or the RLF report, whether at the time of the failure event among neighbouring cells there was a cell with higher radio link quality than those of the source cell and the target cell associated with the failure event, and whether the cell with higher radio link quality is different from cells configured as part of Secondary Cell Group;
determining whether a duration in which the wireless device was dwelling or visiting at a last serving cell before the failure event exceeds a predetermined threshold;
determining whether there is an existing Conditional Handover (CHO) configuration for the wireless device; and
classifying the failure event as conditional handover to a wrong cell, if it is determined that at the time of the failure event there was a cell with higher radio link quality than those of the source cell and the target cell associated with the failure event, that the cell with higher radio link quality is different from cells configured as part of Secondary Cell Group, that the duration in which the wireless device was dwelling or visiting at a last serving cell before the failure event does not exceed the predetermined threshold, and that there is an existing CHO configuration for the wireless device.

In some embodiments, determining whether the duration in which the wireless device was dwelling or visiting at a last serving cell before the failure event exceeds a predetermined threshold may be based on the elapsed time between time of reception of a last RRC reconfiguration message associated with the MCG and time of MCG connection failure, and/or the elapsed time between time of successful execution of the last RRC reconfiguration message associated with the MCG and time of MCG connection failure.

In some embodiments, the method may further comprise receiving wireless device history information from the wireless device. In these embodiments, determining whether the duration in which the wireless device was dwelling or visiting at a last serving cell before the failure event exceeds a predetermined threshold may be based on the wireless device history information.

In some embodiments, classifying the failure event may comprise:
determining, based on the MCG Failure Information, that T310 expiry is the reason of the failure event;
determining that no cell measurement is available in the MCG Failure Information;
determining that the base station sends RRC reconfiguration messages including reconfiguration with sync to the wireless device; and
classifying the failure event as late handover.

In some embodiments, classifying the failure event may comprise:
determining, based on the MCG Failure Information, that T310 expiry is the reason of the failure event;
determining that no cell measurement is available in the MCG Failure Information;
determining that the base station sends RRC reconfiguration messages including reconfiguration with sync to the wireless device;
determining that there is an existing Conditional Handover (CHO) configuration for the wireless device; and
classifying the failure event as late conditional handover.

In some embodiments, the method may further comprise modifying, based on the classification of the failure event, at least one of: a list of the prepared cells associated with the CHO configuration, and one or more conditional handover related parameters.

In some embodiments where the method comprises receiving a RLF report from the wireless device, the method may further comprise determining, based on the RLF report, whether the failure event was followed by a fast MCG link recovery procedure. If it is determined that the failure event was followed by a fast MCG link recovery procedure, the method may further comprise: determining whether the fast MCG link recovery procedure was followed by a handover execution triggered by reception of a RRC reconfiguration message including reconfiguration with sync or trigged by execution of a configured CHO, or whether the fast MCF link recovery procedure was followed by a reestablishment initiated by the wireless device in absence of triggering of an HO execution.

Certain embodiments may provide one or more of the following technical advantage(s). Based on the certain embodiments proposed in the present disclosure, a network node receiving an MCG Failure Information or an RLF report would be able to detect and classify the failure types in the MCG upon receiving the MCG Failure information or the RLF Report as one of the Too Late handover, Too Early handover, or a HO to wrong cell. Hence, it is possible for the network node to take an appropriate counter action after the classification of the failure in the MCG as one of the mentioned types to avoid further occurring of such failures.

In addition, according to certain embodiments, in case of the conditional handover, when a UE is configured with CHO configuration and experiences an MCG Failure, upon receiving the MCG Failure information, the network node can classify the CHO failure type and hence optimize the set of the CHO candidate cell for MCG mobility and or any CHO configuration parameters.

In addition, according to certain embodiments, by logging the timeConnFailure (i.e., elapsed time between reception of the last RRCConnectionReconfiguration message and MCG connection failure), sufficient information can be provided for classifying the failure types and for distinguishing the Too Early and Too Late handover as well as HO to wrong cell cases, making the technique independent from UE history information.

### BRIEF DESCRIPTION OF DRAWINGS

For better understanding of the present disclosure, and to show how it may be put into effect, reference will now be made, by way of example only, to the accompanying drawings, in which:

FIG. 1 is a diagram of NG-RAN overall architecture;

FIG. 2 is a diagram of Higher layer RLF related procedures in LTE;

FIG. 3 is a diagram of MR-DC options;

FIG. 4 is a diagram of MR-DC SRB options;

FIG. 5 is a diagram of MCG failure handling via split SRB1;

FIG. 6 is a schematic diagram of a wireless network in accordance with some embodiments;

FIG. 7 is a schematic diagram of a user equipment in accordance with some embodiments;

FIG. 8 is a schematic diagram of a virtualization environment in accordance with some embodiments;

FIG. 9 is a schematic diagram of a telecommunication network connected via an intermediate network to a host computer in accordance with some embodiments;

FIG. 10 is a schematic diagram of a host computer communicating via a base station with a user equipment over a partially wireless connection in accordance with some embodiments;

FIG. 11 is a flowchart showing methods implemented in a communication system including a host computer, a base station and a user equipment in accordance with some embodiments;

FIG. 12 is a flowchart showing methods implemented in a communication system including a host computer, a base station and a user equipment in accordance with some embodiments;

FIG. 13 is a flowchart showing methods implemented in a communication system including a host computer, a base station and a user equipment in accordance with some embodiments;

FIG. 14 is a flowchart showing methods implemented in a communication system including a host computer, a base station and a user equipment in accordance with some embodiments;

FIG. 15 is a flowchart showing methods in accordance with some embodiments;

FIG. 16 is a flowchart showing method in accordance with some embodiments;

FIG. 17 is a schematic diagram of a virtualization apparatus in accordance with some embodiments; and

FIG. 18 is a schematic diagram of a virtualization apparatus in accordance with some embodiments.

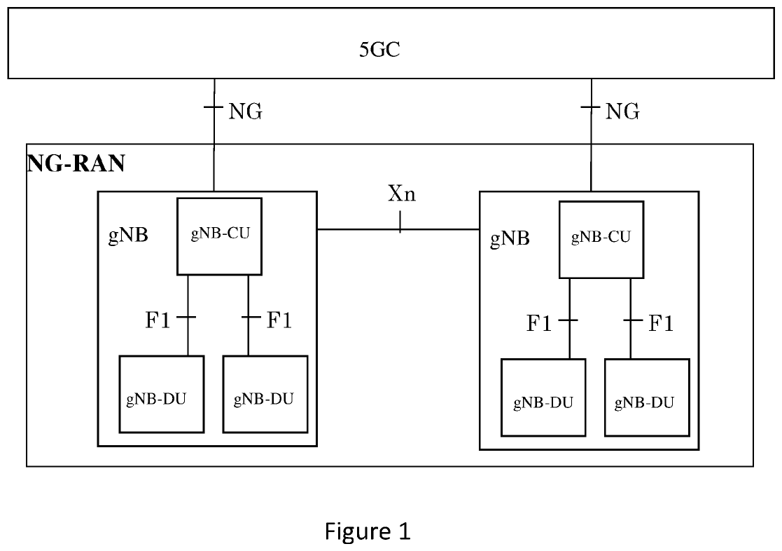

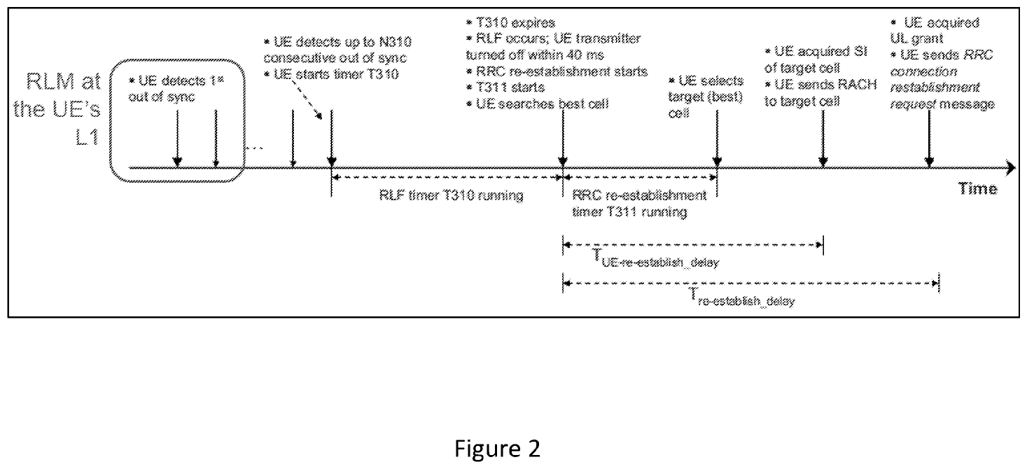

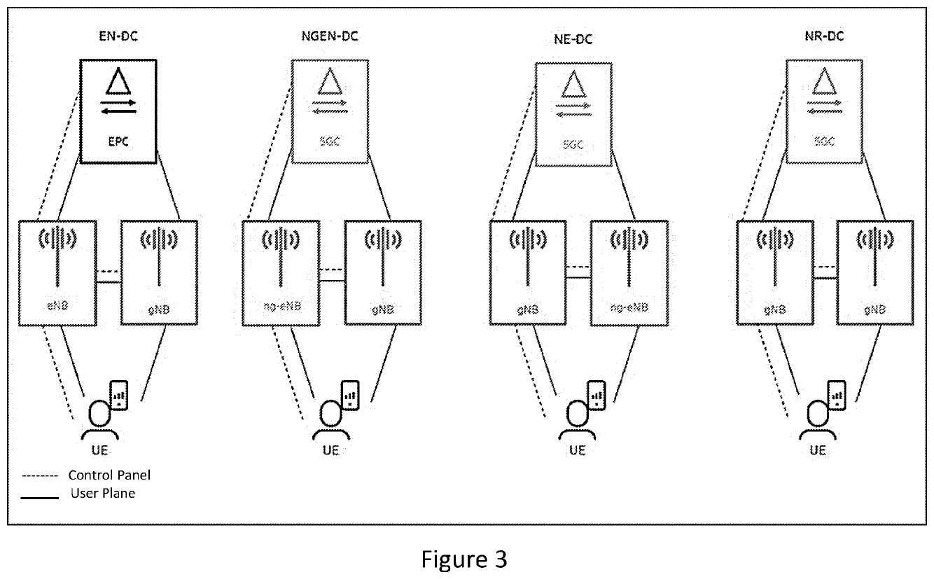

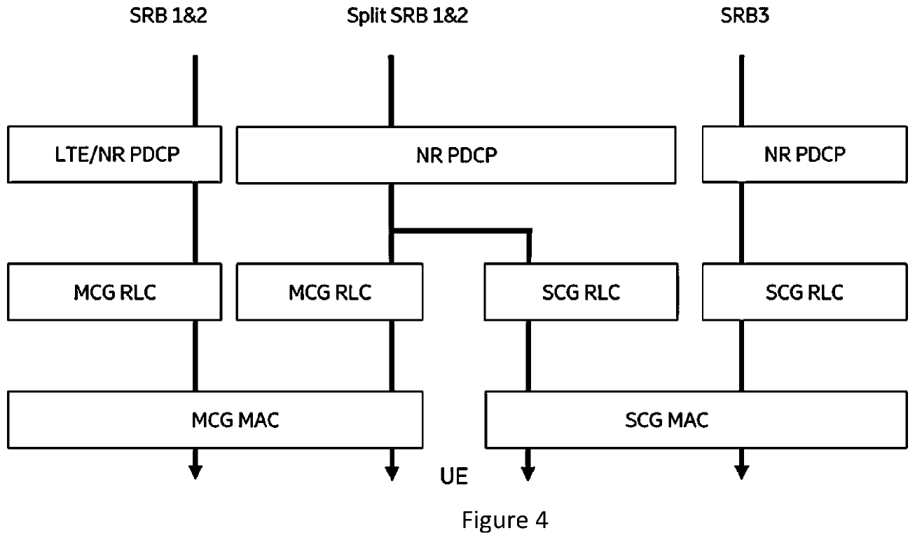

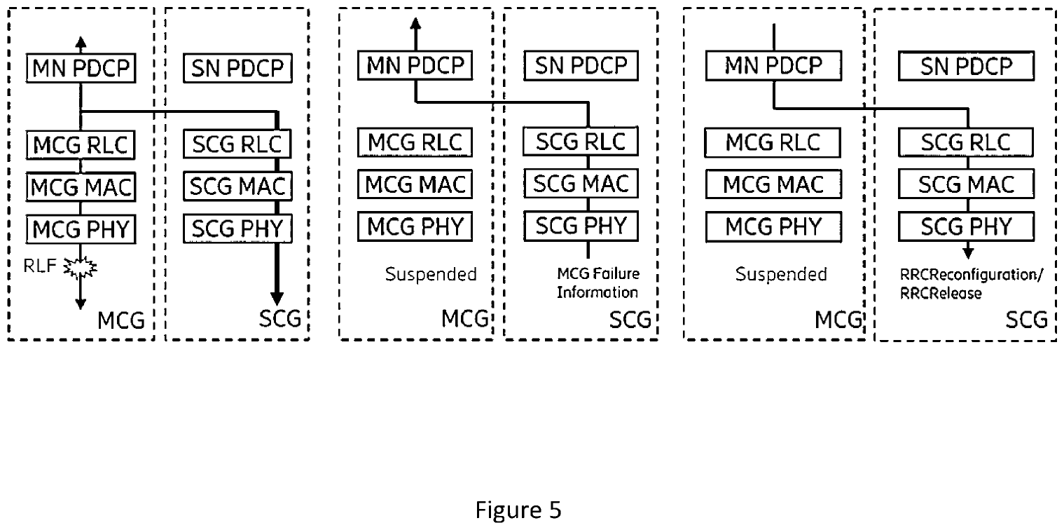

### ADDITIONAL EXPLANATION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

The methods discussed in the present disclosure is applicable to both LTE and NR-RAN nodes.

Detailed Network Side Embodiments

In some embodiments, there are provided methods to be executed by a network node (or base station), e.g., a RAN node such as eNB, gNB, gNB-CU, gNB-CU-CP, etc. in a network for classifying a mobility failure type for an ordinary type handover (i.e., not a conditional handover and not a Dual Active Protocol Stack (DAPS) handover) upon reception of an MCG Failure Information from a UE. The HO failure classification can be performed as follows:

In some embodiments, upon receiving an MCG Failure Information, the network node may classify the associated failure as a Too Late HO, if the measurements provided by the MCG Failure Information reveal that there was a better cell (i.e. with higher radio link quality) than the source cell at the time of the MCG failure, and if the UE history information indicates the UE was dwelling/visiting for a long enough time at the last serving PCell before the MCG Failure.
In some other embodiments, if the UE provides the timeConnFailure as part of the MCG Failure Information, the network node may deduce from it that the UE was dwelling/visiting for a long enough time.
In some other embodiments, the network node may observe from the MCGFailureInformation that T310 expiry is the reason of failure, but no measurement is available as part of MCG failure Information message, and the network node sends RRC reconfiguration with sync to the UE (e.g., sending the UE to the LTE network). Hence, the network node may conclude that the failure is caused due to a Too Late HO.

In some embodiments, upon receiving an MCG failure information, the network node may classify the associated failure as a Too Early HO, if the measurements provided by the MCG Failure Information reveal that the source cell was a better cell (i.e. with higher radio link quality) than the target cell as well as the neighbouring cells at the time of the MCG failure, and if the UE history information indicates the UE was NOT dwelling/visiting for a long enough time at the last serving PCell before the MCG Failure.
In some other embodiments, if the UE provides the timeConnFailure as part of the MCG Failure Information, the network node may deduce from it that the UE was not dwelling/visiting for a long enough time.

In some embodiments, upon receiving an MCG Failure Information, the network node may classify the associated failure as a HO to wrong cell, if the measurements provided by the MCG Failure Information reveal that there was a better cell (i.e. with higher radio link quality) than the source cell and the target cell of the HO among the neighbouring cells at the time of the MCG failure and that better cell is different from the cells configured as part of SCG, and if the UE history information indicates the UE was not dwelling/visiting for a long enough time at the last serving PCell before the MCG Failure.
In some other embodiments, if the UE provides the timeConnFailure as part of the MCG Failure Information, the network node may deduce from it that the UE was not dwelling/visiting for a long enough time.

In some embodiments, upon receiving an RLF-Report including information related to an RLF or handover failure experienced in the MCG, the network node may classify the associated failure as a “too early HO”, “too late HO”, HO to wrong cell based on the information mentioned in the previous embodiments and included in the RLF-Report.

In some embodiments, upon receiving an RLF-Report including information related to an RLF or handover failure experienced in the MCG, the network node may determine whether the said RLF/HOF in the MCG was followed by a fast MCG link recovery. The network node may further determine whether the said fast MCG link recovery was followed by an HO execution triggered by the reception of an RRCReconfiguration with synch or triggered by the execution of a configured CHO, or whether the said fast MCG link recovery was followed by a reestablishment initiated by the UE in absence of a triggering for an HO execution.

Extension to Classification of Conditional Handovers

In some embodiments, there are provided methods to be executed by a network node (or base station), e.g., a RAN node such as eNB, gNB, gNB-CU, gNB-CU-CP, etc. in a network for classifying a mobility failure type for a conditional handover upon reception of an MCG Failure Information from a UE. The output of these methods (i.e., the classified/detected failure type) can be used to modify the list of the CHO prepared/candidate cells or to modify the conditional handover related parameters such as cell individual offset or other non-limiting examples defined in e.g., CondTriggerConfig defined in section 6.3.2 of 3GPP TS 38.331 (as cited above), which is provided below in Table 1:

TABLE 1
Examples of conditional handover related parameters

| | |
|---|---|
| CondTriggerConfig-r16 ::= | SEQUENCE { |
| condEventId | CHOICE { |
| condEventA3 | SEQUENCE { |
| a3-Offset | MeasTriggerQuantityOffset, |
| hysteresis | Hysteresis, |
| timeToTrigger | TimeToTrigger |
| }, | |
| condEventA5 | SEQUENCE { |
| a5-Threshold1 | MeasTriggerQuantity, |
| a5-Threshold2 | MeasTriggerQuantity, |
| hysteresis | Hysteresis, |
| timeToTrigger | TimeToTrigger |
| }, | |
| ... | |

The classification of the conditional HO failure type upon receiving the MCG Failure Information can be performed as follows:

In some embodiments, upon receiving an MCG Failure Information, the network node may classify the associated failure as a Too Late Conditional HO, if the measurements provided by the MCG Failure Information reveal that there was a better cell (i.e. with higher radio link quality) than the source cell at the time of the MCG failure, if there exists a CHO configuration (with CHO prepared cells) for the UE, and if the UE history information indicates the UE was dwelling/visiting for a long enough time at the last serving PCell before the MCG Failure.
In some other embodiments, if the UE provides the timeConnFailure as part of the MCG Failure Information, the network node may deduce from it that the UE was dwelling/visiting for a long enough time.
In some other embodiments, the network node may observe from the MCGFailureInformation that T310 expiry is the reason of failure but no measurement is available as part of MCG failure Information message, and the network node sends RRC reconfiguration with sync to the UE (e.g., sending the UE to the LTE network). Hence, network node may conclude that the failure is caused due to a Too Late Conditional HO.

In some embodiments, upon receiving an MCG failure information the network node may classify the associated failure as a Too Early Conditional HO, if the measurements provided by the MCG Failure Information reveal that the source cell was a better cell (i.e. with higher radio link quality) than the target cell as well as the neighbouring cells at the time of the MCG failure, if there exists a CHO configuration (with CHO prepared cells) for the UE, and if the UE history information indicates the UE was not dwelling/visiting for a long enough time at the last serving PCell before the MCG Failure.
In some other embodiments, if the UE provides the timeConnFailure as part of the MCG Failure Information, the network node may deduce from it that the UE was not dwelling/visiting for a long enough time.

In an embodiment, upon receiving an MCG Failure Information, the network node may classify the associated failure as a Conditional HO to wrong cell, if the measurements provided by the MCG Failure Information reveal that there was a better cell (i.e. with higher radio link quality) than the source cell and the target cell of the HO among the neighbouring cells at the time of the MCG failure and that better cell is different from the cells configured as part of SCG, if there exists a CHO configuration (with CHO prepared cells) for the UE, and if the UE history information indicates the UE was not dwelling/visiting for a long enough time at the last serving PCell before the MCG Failure.
In another embodiment, if the UE provides the timeConnFailure as part of the MCG Failure Information, the network node may deduce from it that the UE was not dwelling/visiting for a long enough time.

UE Side Embodiments

In some embodiments, there are provided methods to be executed by a wireless terminal (or a user equipment) for logging information as part of MCG Failure Information.

The information may include at least time until Connection Failure (so called timeConnFailure in 3GPP TS 38.331). That is, the elapsed time between reception of the last RRCReconfiguration message including the reconfigurationWithSync and the MCG connection failure.

The information may include another flavour of the time until Connection Failure. That is, the elapsed time between successful execution of the last RRCReconfiguration message including the reconfigurationWithSync and the MCG connection failure.
Note that the above signals, e.g., RRC reconfiguration messages, are associated with the master leg and master cell group (MCG).

In some embodiments, there are provided methods to be executed by a wireless terminal to log additional information as part of RLF-Report to indicate the outcome of the MCG Failure recovery procedure. Such information may include:
Flag indicating whether at the time of the failure, the UE was configured for fast MCG link recovery, i.e. T316 was configured
A flag indicating that the UE performed a fast MCG link recovery, i.e. the UE transmitted an MCG Failure Information to the SCG, but that the MCG recovery failed, i.e. T316 expired before the UE executed the RRCReconfiguration with sync (i.e. before receiving an HO command or before executing a previously configured CHO configuration)
   In such case, the UE may also include some further information such as:
      the cell ID of the cell in which the UE attempted a reestablishment after T316 expiry, and an indication of whether such cell was in the list of CHO candidate cells or not
      Information about the time elapsed between the RLF/HOF in the MCG (or the execution of the handover that resulted in an HOF) and the reestablishment in a cell after T316 expiry
      Information about the time elapsed between the RLF/HOF in the MCG (or the execution of the handover that resulted in an HOF) and the entering of the UE in IDLE mode because of no suitable cell found after T316 expiry and possible failure of the reestablishment attempt in another cell
A flag indicating that the UE had a CHO configuration when the RLF/HOF was experienced, and optionally the list of candidate CHO target cells in case the UE had a CHO configuration.
A flag indicating that the UE performed a fast MCG link recovery (i.e., the UE transmitted an MCG Failure Information to the SCG), and that the MCG link recovery succeeded (i.e., the UE executed the HO towards a PCell (wherein the HO could be a CHO or an ordinary HO)), or the UE received an RRC release message, before T316 expired
   In such case, the UE may also include some further information such as:
      the cell ID of the cell in which the HO was executed
      A flag indicating whether the executed HO was in response of a received HO command (RRC Reconfiguration with sync) or in response of a CHO configuration, i.e. the UE selected a cell in the list of configured CHO candidate cells
      A flag indicating whether the said executed HO was successful or not (i.e., the UE completed the HO in the target cell), or alternatively the cell ID of the cell in which the UE attempted the reestablishment if the said executed HO failed. Or a flag indicating that no suitable cell was found upon failure of the HO towards the target cell, and possible failure of the reestablishment attempt
      Information about the time elapsed between the RLF/HOF in the MCG (or the execution of the handover that resulted in an HOF) and the HO execution before T316 expiry
      Information about the time elapsed between the RLF/HOF in the MCG (or the execution of the handover that resulted in an HOF) and the point in time in which the HO execution is declared successful/completed
      Information about the time elapsed between the RLF/HOF in the MCG (or the execution of the handover that resulted in an HOF) and the point in time in which the HO execution is declared unsuccessful (i.e. related T304 expiry)
      Information about the time elapsed between the RLF/HOF in the MCG (or the execution of the handover that resulted in an HOF) and successful reestablishment after unsuccessful HO execution
      Information about the time elapsed between the RLF/HOF in the MCG (or the execution of the handover that resulted in an HOF) and the UE entering IDLE mode after unsuccessful reestablishment and unsuccessful HO execution

In some embodiments, the RLF report may not be canceled upon HO execution, so that the UE can include those information, from the above list of information, that are collected after HO execution, e.g. the cell ID of the cell in which the UE executes the handover, the flag indicating whether the said HO execution is successful or not, etc.

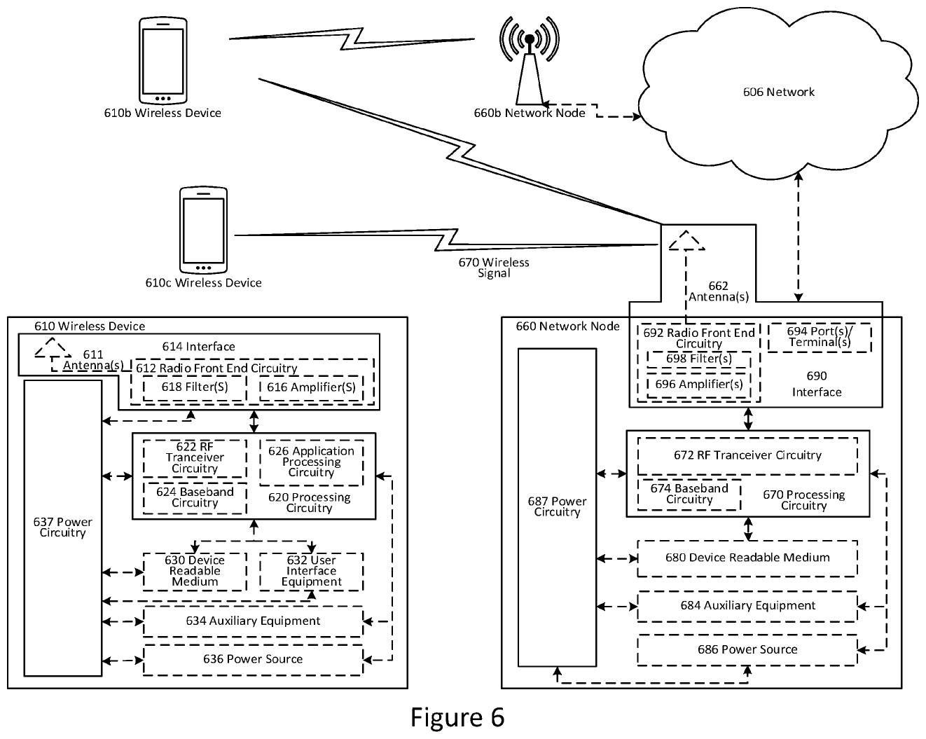

Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network 606, network nodes 660 and 660b, and WDs 610, 610b, and 610c. In practice, a wireless network may further include any additional elements suitable to support communication between wireless devices or between a wireless device and another communication device, such as a landline telephone, a service provider, or any other network node or end device. Of the illustrated components, network node 660 and wireless device (WD) 610 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (Wi Max), Bluetooth, Z-Wave and/or ZigBee standards.

Network 606 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 660 and WD 610 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 660 includes processing circuitry 670, device readable medium 680, interface 690, auxiliary equipment 684, power source 686, power circuitry 687, and antenna 662. Although network node 660 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 660 are depicted as single boxes located within a larger box, or nested within multiple boxes, in practice, a network node may comprise multiple different physical components that make up a single illustrated component (e.g., device readable medium 680 may comprise multiple separate hard drives as well as multiple RAM modules).

Similarly, network node 660 may be composed of multiple physically separate components (e.g., a NodeB component and a RNC component, or a BTS component and a BSC component, etc.), which may each have their own respective components. In certain scenarios in which network node 660 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 660 may be configured to support multiple radio access technologies (RATs). In such embodiments, some components may be duplicated (e.g., separate device readable medium 680 for the different RATs) and some components may be reused (e.g., the same antenna 662 may be shared by the RATs). Network node 660 may also include multiple sets of the various illustrated components for different wireless technologies integrated into network node 660, such as, for example, GSM, WCDMA, LTE, NR, WiFi, or Bluetooth wireless technologies. These wireless technologies may be integrated into the same or different chip or set of chips and other components within network node 660.

Processing circuitry 670 is configured to perform any determining, calculating, or similar operations (e.g., certain obtaining operations) described herein as being provided by a network node. These operations performed by processing circuitry 670 may include processing information obtained by processing circuitry 670 by, for example, converting the obtained information into other information, comparing the obtained information or converted information to information stored in the network node, and/or performing one or more operations based on the obtained information or converted information, and as a result of said processing making a determination.

Processing circuitry 670 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 660 components, such as device readable medium 680, network node 660 functionality. For example, processing circuitry 670 may execute instructions stored in device readable medium 680 or in memory within processing circuitry 670. Such functionality may include providing any of the various wireless features, functions, or benefits discussed herein. In some embodiments, processing circuitry 670 may include a system on a chip (SOC).

In some embodiments, processing circuitry 670 may include one or more of radio frequency (RF) transceiver circuitry 672 and baseband processing circuitry 674. In some embodiments, radio frequency (RF) transceiver circuitry 672 and baseband processing circuitry 674 may be on separate chips (or sets of chips), boards, or units, such as radio units and digital units. In alternative embodiments, part or all of RF transceiver circuitry 672 and baseband processing circuitry 674 may be on the same chip or set of chips, boards, or units

In certain embodiments, some or all of the functionality described herein as being provided by a network node, base station, eNB or other such network device may be performed by processing circuitry 670 executing instructions stored on device readable medium 680 or memory within processing circuitry 670. In alternative embodiments, some or all of the functionality may be provided by processing circuitry 670 without executing instructions stored on a separate or discrete device readable medium, such as in a hard-wired manner. In any of those embodiments, whether executing instructions stored on a device readable storage medium or not, processing circuitry 670 can be configured to perform the described functionality. The benefits provided by such functionality are not limited to processing circuitry 670 alone or to other components of network node 660, but are enjoyed by network node 660 as a whole, and/or by end users and the wireless network generally.

Device readable medium 680 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 670. Device readable medium 680 may store any suitable instructions, data or information, including a computer program, software, an application including one or more of logic, rules, code, tables, etc. and/or other instructions capable of being executed by processing circuitry 670 and, utilized by network node 660. Device readable medium 680 may be used to store any calculations made by processing circuitry 670 and/or any data received via interface 690. In some embodiments, processing circuitry 670 and device readable medium 680 may be considered to be integrated.

Interface 690 is used in the wired or wireless communication of signalling and/or data between network node 660, network 606, and/or WDs 610. As illustrated, interface 690 comprises port(s)/terminal(s) 694 to send and receive data, for example to and from network 606 over a wired connection. Interface 690 also includes radio front end circuitry 692 that may be coupled to, or in certain embodiments a part of, antenna 662. Radio front end circuitry 692 comprises filters 698 and amplifiers 696. Radio front end circuitry 692 may be connected to antenna 662 and processing circuitry 670. Radio front end circuitry may be configured to condition signals communicated between antenna 662 and processing circuitry 670. Radio front end circuitry 692 may receive digital data that is to be sent out to other network nodes or WDs via a wireless connection. Radio front end circuitry 692 may convert the digital data into a radio signal having the appropriate channel and bandwidth parameters using a combination of filters 698 and/or amplifiers 696. The radio signal may then be transmitted via antenna 662. Similarly, when receiving data, antenna 662 may collect radio signals which are then converted into digital data by radio front end circuitry 692. The digital data may be passed to processing circuitry 670. In other embodiments, the interface may comprise different components and/or different combinations of components.

In certain alternative embodiments, network node 660 may not include separate radio front end circuitry 692, instead, processing circuitry 670 may comprise radio front end circuitry and may be connected to antenna 662 without separate radio front end circuitry 692. Similarly, in some embodiments, all or some of RF transceiver circuitry 672 may be considered a part of interface 690. In still other embodiments, interface 690 may include one or more ports or terminals 694, radio front end circuitry 692, and RF transceiver circuitry 672, as part of a radio unit (not shown), and interface 690 may communicate with baseband processing circuitry 674, which is part of a digital unit (not shown).

Antenna 662 may include one or more antennas, or antenna arrays, configured to send and/or receive wireless signals. Antenna 662 may be coupled to radio front end circuitry 690 and may be any type of antenna capable of transmitting and receiving data and/or signals wirelessly. In some embodiments, antenna 662 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 662 may be separate from network node 660 and may be connectable to network node 660 through an interface or port.

Antenna 662, interface 690, and/or processing circuitry 670 may be configured to perform any receiving operations and/or certain obtaining operations described herein as being performed by a network node. Any information, data and/or signals may be received from a wireless device, another network node and/or any other network equipment. Similarly, antenna 662, interface 690, and/or processing circuitry 670 may be configured to perform any transmitting operations described herein as being performed by a network node. Any information, data and/or signals may be transmitted to a wireless device, another network node and/or any other network equipment.

Power circuitry 687 may comprise, or be coupled to, power management circuitry and is configured to supply the components of network node 660 with power for performing the functionality described herein. Power circuitry 687 may receive power from power source 686. Power source 686 and/or power circuitry 687 may be configured to provide power to the various components of network node 660 in a form suitable for the respective components (e.g., at a voltage and current level needed for each respective component). Power source 686 may either be included in, or external to, power circuitry 687 and/or network node 660. For example, network node 660 may be connectable to an external power source (e.g., an electricity outlet) via an input circuitry or interface such as an electrical cable, whereby the external power source supplies power to power circuitry 687. As a further example, power source 686 may comprise a source of power in the form of a battery or battery pack which is connected to, or integrated in, power circuitry 687. The battery may provide backup power should the external power source fail. Other types of power sources, such as photovoltaic devices, may also be used.

Alternative embodiments of network node 660 may include additional components beyond those shown in FIG. 6 that may be responsible for providing certain aspects of the network node's functionality, including any of the functionality described herein and/or any functionality necessary to support the subject matter described herein. For example, network node 660 may include user interface equipment to allow input of information into network node 660 and to allow output of information from network node 660. This may allow a user to perform diagnostic, maintenance, repair, and other administrative functions for network node 660.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (Vol P) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc.. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 610 includes antenna 611, interface 614, processing circuitry 620, device readable medium 630, user interface equipment 632, auxiliary equipment 634, power source 636 and power circuitry 637. WD 610 may include multiple sets of one or more of the illustrated components for different wireless technologies supported by WD 610, such as, for example, GSM, WCDMA, LTE, NR, WiFi, WiMAX, or Bluetooth wireless technologies, just to mention a few. These wireless technologies may be integrated into the same or different chips or set of chips as other components within WD 610.

Antenna 611 may include one or more antennas or antenna arrays, configured to send and/or receive wireless signals, and is connected to interface 614. In certain alternative embodiments, antenna 611 may be separate from WD 610 and be connectable to WD 610 through an interface or port. Antenna 611, interface 614, and/or processing circuitry 620 may be configured to perform any receiving or transmitting operations described herein as being performed by a WD. Any information, data and/or signals may be received from a network node and/or another WD. In some embodiments, radio front end circuitry and/or antenna 611 may be considered an interface.

As illustrated, interface 614 comprises radio front end circuitry 612 and antenna 611. Radio front end circuitry 612 comprise one or more filters 618 and amplifiers 616. Radio front end circuitry 614 is connected to antenna 611 and processing circuitry 620, and is configured to condition signals communicated between antenna 611 and processing circuitry 620. Radio front end circuitry 612 may be coupled to or a part of antenna 611. In some embodiments, WD 610 may not include separate radio front end circuitry 612; rather, processing circuitry 620 may comprise radio front end circuitry and may be connected to antenna 611. Similarly, in some embodiments, some or all of RF transceiver circuitry 622 may be considered a part of interface 614. Radio front end circuitry 612 may receive digital data that is to be sent out to other network nodes or WDs via a wireless connection. Radio front end circuitry 612 may convert the digital data into a radio signal having the appropriate channel and bandwidth parameters using a combination of filters 618 and/or amplifiers 616. The radio signal may then be transmitted via antenna 611. Similarly, when receiving data, antenna 611 may collect radio signals which are then converted into digital data by radio front end circuitry 612. The digital data may be passed to processing circuitry 620. In other embodiments, the interface may comprise different components and/or different combinations of components.

Processing circuitry 620 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 610 components, such as device readable medium 630, WD 610 functionality. Such functionality may include providing any of the various wireless features or benefits discussed herein. For example, processing circuitry 620 may execute instructions stored in device readable medium 630 or in memory within processing circuitry 620 to provide the functionality disclosed herein.

As illustrated, processing circuitry 620 includes one or more of RF transceiver circuitry 622, baseband processing circuitry 624, and application processing circuitry 626. In other embodiments, the processing circuitry may comprise different components and/or different combinations of components. In certain embodiments processing circuitry 620 of WD 610 may comprise a SOC. In some embodiments, RF transceiver circuitry 622, baseband processing circuitry 624, and application processing circuitry 626 may be on separate chips or sets of chips. In alternative embodiments, part or all of baseband processing circuitry 624 and application processing circuitry 626 may be combined into one chip or set of chips, and RF transceiver circuitry 622 may be on a separate chip or set of chips. In still alternative embodiments, part or all of RF transceiver circuitry 622 and baseband processing circuitry 624 may be on the same chip or set of chips, and application processing circuitry 626 may be on a separate chip or set of chips. In yet other alternative embodiments, part or all of RF transceiver circuitry 622, baseband processing circuitry 624, and application processing circuitry 626 may be combined in the same chip or set of chips. In some embodiments, RF transceiver circuitry 622 may be a part of interface 614. RF transceiver circuitry 622 may condition RF signals for processing circuitry 620.

In certain embodiments, some or all of the functionality described herein as being performed by a WD may be provided by processing circuitry 620 executing instructions stored on device readable medium 630, which in certain embodiments may be a computer-readable storage medium. In alternative embodiments, some or all of the functionality may be provided by processing circuitry 620 without executing instructions stored on a separate or discrete device readable storage medium, such as in a hard-wired manner. In any of those particular embodiments, whether executing instructions stored on a device readable storage medium or not, processing circuitry 620 can be configured to perform the described functionality. The benefits provided by such functionality are not limited to processing circuitry 620 alone or to other components of WD 610, but are enjoyed by WD 610 as a whole, and/or by end users and the wireless network generally.

Processing circuitry 620 may be configured to perform any determining, calculating, or similar operations (e.g., certain obtaining operations) described herein as being performed by a WD. These operations, as performed by processing circuitry 620, may include processing information obtained by processing circuitry 620 by, for example, converting the obtained information into other information, comparing the obtained information or converted information to information stored by WD 610, and/or performing one or more operations based on the obtained information or converted information, and as a result of said processing making a determination.

Device readable medium 630 may be operable to store a computer program, software, an application including one or more of logic, rules, code, tables, etc. and/or other instructions capable of being executed by processing circuitry 620. Device readable medium 630 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 620. In some embodiments, processing circuitry 620 and device readable medium 630 may be considered to be integrated.

User interface equipment 632 may provide components that allow for a human user to interact with WD 610. Such interaction may be of many forms, such as visual, audial, tactile, etc. User interface equipment 632 may be operable to produce output to the user and to allow the user to provide input to WD 610. The type of interaction may vary depending on the type of user interface equipment 632 installed in WD 610. For example, if WD 610 is a smart phone, the interaction may be via a touch screen; if WD 610 is a smart meter, the interaction may be through a screen that provides usage (e.g., the number of gallons used) or a speaker that provides an audible alert (e.g., if smoke is detected). User interface equipment 632 may include input interfaces, devices and circuits, and output interfaces, devices and circuits. User interface equipment 632 is configured to allow input of information into WD 610, and is connected to processing circuitry 620 to allow processing circuitry 620 to process the input information. User interface equipment 632 may include, for example, a microphone, a proximity or other sensor, keys/buttons, a touch display, one or more cameras, a USB port, or other input circuitry. User interface equipment 632 is also configured to allow output of information from WD 610, and to allow processing circuitry 620 to output information from WD 610. User interface equipment 632 may include, for example, a speaker, a display, vibrating circuitry, a USB port, a headphone interface, or other output circuitry. Using one or more input and output interfaces, devices, and circuits, of user interface equipment 632, WD 610 may communicate with end users and/or the wireless network, and allow them to benefit from the functionality described herein.

Auxiliary equipment 634 is operable to provide more specific functionality which may not be generally performed by WDs. This may comprise specialized sensors for doing measurements for various purposes, interfaces for additional types of communication such as wired communications etc. The inclusion and type of components of auxiliary equipment 634 may vary depending on the embodiment and/or scenario.

Power source 636 may, in some embodiments, be in the form of a battery or battery pack. Other types of power sources, such as an external power source (e.g., an electricity outlet), photovoltaic devices or power cells, may also be used. WD 610 may further comprise power circuitry 637 for delivering power from power source 636 to the various parts of WD 610 which need power from power source 636 to carry out any functionality described or indicated herein. Power circuitry 637 may in certain embodiments comprise power management circuitry. Power circuitry 637 may additionally or alternatively be operable to receive power from an external power source; in which case WD 610 may be connectable to the external power source (such as an electricity outlet) via input circuitry or an interface such as an electrical power cable. Power circuitry 637 may also in certain embodiments be operable to deliver power from an external power source to power source 636. This may be, for example, for the charging of power source 636. Power circuitry 637 may perform any formatting, converting, or other modification to the power from power source 636 to make the power suitable for the respective components of WD 610 to which power is supplied.

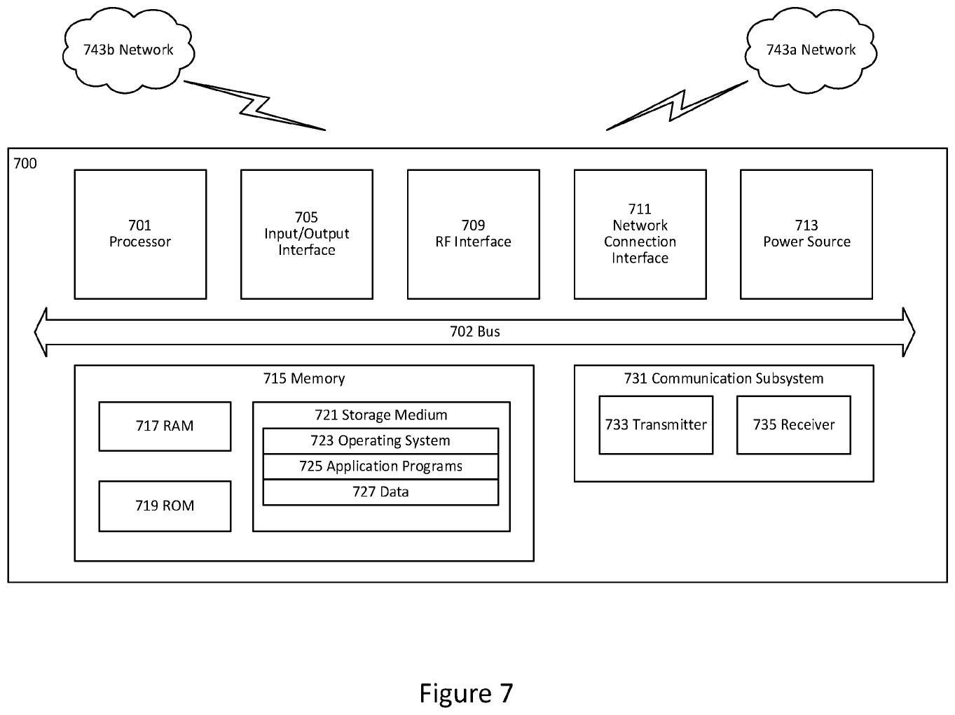

FIG. 7 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 700 may be any UE identified by the 3^{rd} Generation Partnership Project (3GPP), including a NB-IoT UE, a machine type communication (MTC) UE, and/or an enhanced MTC (eMTC) UE. UE 700, as illustrated in FIG. 7, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 7 is a UE, the components discussed herein are equally applicable to a WD, and vice-versa.

In FIG. 7, UE 700 includes processing circuitry 701 that is operatively coupled to input/output interface 705, radio frequency (RF) interface 709, network connection interface 711, memory 715 including random access memory (RAM) 717, read-only memory (ROM) 719, and storage medium 721 or the like, communication subsystem 731, power source 733, and/or any other component, or any combination thereof. Storage medium 721 includes operating system 723, application program 725, and data 727. In other embodiments, storage medium 721 may include other similar types of information. Certain UEs may utilize all of the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 701 may be configured to process computer instructions and data. Processing circuitry 701 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 701 may include two central processing units (CPUs). Data may be information in a form suitable for use by a computer.

In the depicted embodiment, input/output interface 705 may be configured to provide a communication interface to an input device, output device, or input and output device. UE 700 may be configured to use an output device via input/output interface 705. An output device may use the same type of interface port as an input device. For example, a USB port may be used to provide input to and output from UE 700. The output device may be a speaker, a sound card, a video card, a display, a monitor, a printer, an actuator, an emitter, a smartcard, another output device, or any combination thereof. UE 700 may be configured to use an input device via input/output interface 705 to allow a user to capture information into UE 700. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 709 may be configured to provide a communication interface to RF components such as a transmitter, a receiver, and an antenna. Network connection interface 711 may be configured to provide a communication interface to network 743a. Network 743a may encompass wired and/or wireless networks such as a local-area network (LAN), a wide-area network (WAN), a computer network, a wireless network, a telecommunications network, another like network or any combination thereof. For example, network 743a may comprise a Wi-Fi network. Network connection interface 711 may be configured to include a receiver and a transmitter interface used to communicate with one or more other devices over a communication network according to one or more communication protocols, such as Ethernet, TCP/IP, SONET, ATM, or the like. Network connection interface 711 may implement receiver and transmitter functionality appropriate to the communication network links (e.g., optical, electrical, and the like). The transmitter and receiver functions may share circuit components, software or firmware, or alternatively may be implemented separately.

RAM 717 may be configured to interface via bus 702 to processing circuitry 701 to provide storage or caching of data or computer instructions during the execution of software programs such as the operating system, application programs, and device drivers. ROM 719 may be configured to provide computer instructions or data to processing circuitry 701. For example, ROM 719 may be configured to store invariant low-level system code or data for basic system functions such as basic input and output (I/O), startup, or reception of keystrokes from a keyboard that are stored in a non-volatile memory. Storage medium 721 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 721 may be configured to include operating system 723, application program 725 such as a web browser application, a widget or gadget engine or another application, and data file 727. Storage medium 721 may store, for use by UE 700, any of a variety of various operating systems or combinations of operating systems.

Storage medium 721 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DI MM), synchronous dynamic random access memory (SDRAM), external micro-DIM M SDRAM, smartcard memory such as a subscriber identity module or a removable user identity (SIM/RUIM) module, other memory, or any combination thereof. Storage medium 721 may allow UE 700 to access computer-executable instructions, application programs or the like, stored on transitory or non-transitory memory media, to off-load data, or to upload data. An article of manufacture, such as one utilizing a communication system may be tangibly embodied in storage medium 721, which may comprise a device readable medium.

In FIG. 7, processing circuitry 701 may be configured to communicate with network 743b using communication subsystem 731. Network 743a and network 743b may be the same network or networks or different network or networks. Communication subsystem 731 may be configured to include one or more transceivers used to communicate with network 743b. For example, communication subsystem 731 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 733 and/or receiver 735 to implement transmitter or receiver functionality, respectively, appropriate to the RAN links (e.g., frequency allocations and the like). Further, transmitter 733 and receiver 735 of each transceiver may share circuit components, software or firmware, or alternatively may be implemented separately.

In the illustrated embodiment, the communication functions of communication subsystem 731 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 731 may include cellular communication, Wi-Fi communication, Bluetooth communication, and GPS communication. Network 743b may encompass wired and/or wireless networks such as a local-area network (LAN), a wide-area network (WAN), a computer network, a wireless network, a telecommunications network, another like network or any combination thereof. For example, network 743b may be a cellular network, a Wi-Fi network, and/or a near-field network. Power source 713 may be configured to provide alternating current (AC) or direct current (DC) power to components of UE 700.

The features, benefits and/or functions described herein may be implemented in one of the components of UE 700 or partitioned across multiple components of UE 700. Further, the features, benefits, and/or functions described herein may be implemented in any combination of hardware, software or firmware. In one example, communication subsystem 731 may be configured to include any of the components described herein. Further, processing circuitry 701 may be configured to communicate with any of such components over bus 702. In another example, any of such components may be represented by program instructions stored in memory that when executed by processing circuitry 701 perform the corresponding functions described herein. In another example, the functionality of any of such components may be partitioned between processing circuitry 701 and communication subsystem 731. In another example, the non-computationally intensive functions of any of such components may be implemented in software or firmware and the computationally intensive functions may be implemented in hardware.

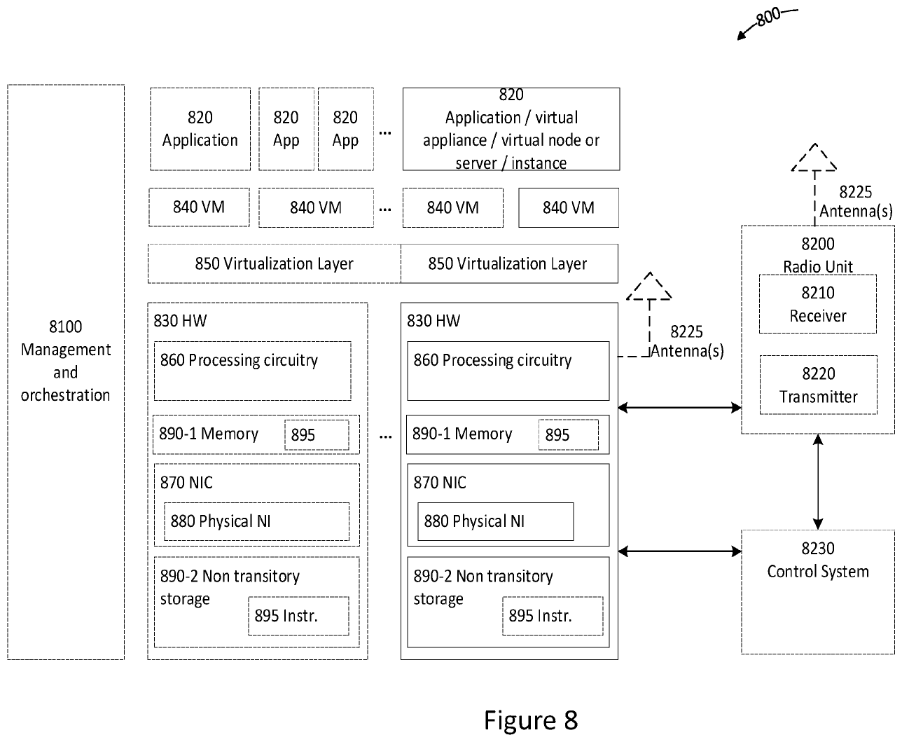

FIG. 8 is a schematic block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 800 hosted by one or more of hardware nodes 830. Further, in embodiments in which the virtual node is not a radio access node or does not require radio connectivity (e.g., a core network node), then the network node may be entirely virtualized.

The functions may be implemented by one or more applications 820 (which may alternatively be called software instances, virtual appliances, network functions, virtual nodes, virtual network functions, etc.) operative to implement some of the features, functions, and/or benefits of some of the embodiments disclosed herein. Applications 820 are run in virtualization environment 800 which provides hardware 830 comprising processing circuitry 860 and memory 890. Memory 890 contains instructions 895 executable by processing circuitry 860 whereby application 820 is operative to provide one or more of the features, benefits, and/or functions disclosed herein.

Virtualization environment 800, comprises general-purpose or special-purpose network hardware devices 830 comprising a set of one or more processors or processing circuitry 860, which may be commercial off-the-shelf (COTS) processors, dedicated Application Specific Integrated Circuits (ASICs), or any other type of processing circuitry including digital or analog hardware components or special purpose processors. Each hardware device may comprise memory 890-1 which may be non-persistent memory for temporarily storing instructions 895 or software executed by processing circuitry 860. Each hardware device may comprise one or more network interface controllers (NICs) 870, also known as network interface cards, which include physical network interface 880. Each hardware device may also include non-transitory, persistent, machine-readable storage media 890-2 having stored therein software 895 and/or instructions executable by processing circuitry 860. Software 895 may include any type of software including software for instantiating one or more virtualization layers 850 (also referred to as hypervisors), software to execute virtual machines 840 as well as software allowing it to execute functions, features and/or benefits described in relation with some embodiments described herein.

Virtual machines 840, comprise virtual processing, virtual memory, virtual networking or interface and virtual storage, and may be run by a corresponding virtualization layer 850 or hypervisor. Different embodiments of the instance of virtual appliance 820 may be implemented on one or more of virtual machines 840, and the implementations may be made in different ways.

During operation, processing circuitry 860 executes software 895 to instantiate the hypervisor or virtualization layer 850, which may sometimes be referred to as a virtual machine monitor (VMM). Virtualization layer 850 may present a virtual operating platform that appears like networking hardware to virtual machine 840.

As shown in FIG. 8, hardware 830 may be a standalone network node with generic or specific components. Hardware 830 may comprise antenna 8225 and may implement some functions via virtualization. Alternatively, hardware 830 may be part of a larger cluster of hardware (e.g. such as in a data center or customer premise equipment (CPE)) where many hardware nodes work together and are managed via management and orchestration (MANO) 8100, which, among others, oversees lifecycle management of applications 820.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 840 may be a software implementation of a physical machine that runs programs as if they were executing on a physical, non-virtualized machine. Each of virtual machines 840, and that part of hardware 830 that executes that virtual machine, be it hardware dedicated to that virtual machine and/or hardware shared by that virtual machine with others of the virtual machines 840, forms a separate virtual network elements (VNE).

Still in the context of NFV, Virtual Network Function (VNF) is responsible for handling specific network functions that run in one or more virtual machines 840 on top of hardware networking infrastructure 830 and corresponds to application 820 in FIG. 8.

In some embodiments, one or more radio units 8200 that each include one or more transmitters 8220 and one or more receivers 8210 may be coupled to one or more antennas 8225. Radio units 8200 may communicate directly with hardware nodes 830 via one or more appropriate network interfaces and may be used in combination with the virtual components to provide a virtual node with radio capabilities, such as a radio access node or a base station.

In some embodiments, some signalling can be effected with the use of control system 8230 which may alternatively be used for communication between the hardware nodes 830 and radio units 8200.

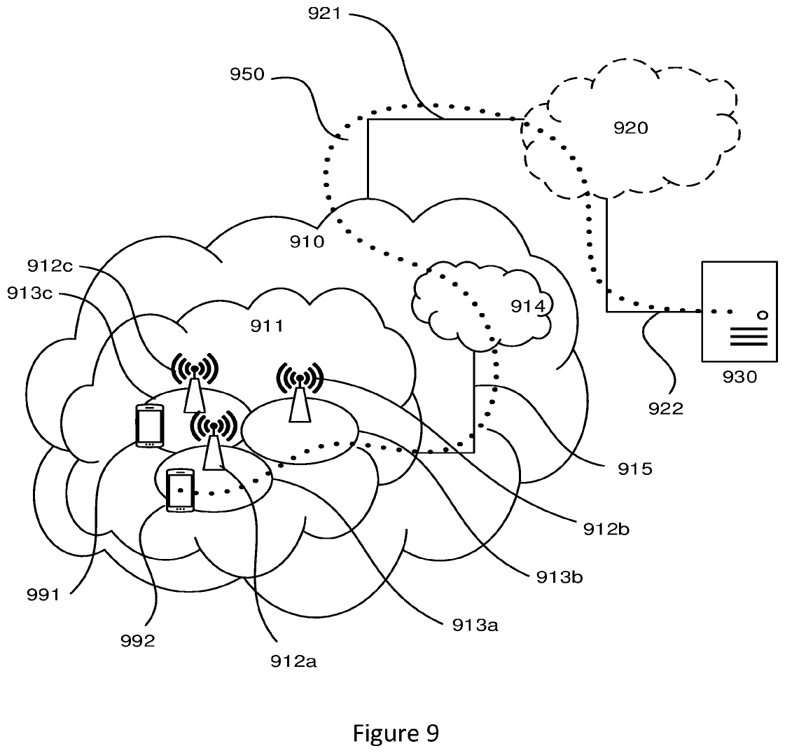

With reference to FIG. 9, in accordance with an embodiment, a communication system includes telecommunication network 910, such as a 3GPP-type cellular network, which comprises access network 911, such as a radio access network, and core network 914. Access network 911 comprises a plurality of base stations 912a, 912b, 912c, such as NBs, eNBs, gNBs or other types of wireless access points, each defining a corresponding coverage area 913a, 913b, 913c. Each base station 912a, 912b, 912c is connectable to core network 914 over a wired or wireless connection 915. A first UE 991 located in coverage area 913c is configured to wirelessly connect to, or be paged by, the corresponding base station 912c. A second UE 992 in coverage area 913a is wirelessly connectable to the corresponding base station 912a. While a plurality of UEs 991, 992 are illustrated in this example, the disclosed embodiments are equally applicable to a situation where a sole UE is in the coverage area or where a sole UE is connecting to the corresponding base station 912.

Telecommunication network 910 is itself connected to host computer 930, which may be embodied in the hardware and/or software of a standalone server, a cloud-implemented server, a distributed server or as processing resources in a server farm. Host computer 930 may be under the ownership or control of a service provider, or may be operated by the service provider or on behalf of the service provider. Connections 921 and 922 between telecommunication network 910 and host computer 930 may extend directly from core network 914 to host computer 930 or may go via an optional intermediate network 920. Intermediate network 920 may be one of, or a combination of more than one of, a public, private or hosted network; intermediate network 920, if any, may be a backbone network or the Internet; in particular, intermediate network 920 may comprise two or more sub-networks (not shown).

The communication system of FIG. 9 as a whole enables connectivity between the connected UEs 991, 992 and host computer 930. The connectivity may be described as an over-the-top (OTT) connection 950. Host computer 930 and the connected UEs 991, 992 are configured to communicate data and/or signaling via OTT connection 950, using access network 911, core network 914, any intermediate network 920 and possible further infrastructure (not shown) as intermediaries. OTT connection 950 may be transparent in the sense that the participating communication devices through which OTT connection 950 passes are unaware of routing of uplink and downlink communications. For example, base station 912 may not or need not be informed about the past routing of an incoming downlink communication with data originating from host computer 930 to be forwarded (e.g., handed over) to a connected UE 991. Similarly, base station 912 need not be aware of the future routing of an outgoing uplink communication originating from the UE 991 towards the host computer 930.

Example implementations, in accordance with an embodiment, of the UE, base station and host computer discussed in the preceding paragraphs will now be described with reference to FIG. 10. In communication system 1000, host computer 1010 comprises hardware 1015 including communication interface 1016 configured to set up and maintain a wired or wireless connection with an interface of a different communication device of communication system 1000. Host computer 1010 further comprises processing circuitry 1018, which may have storage and/or processing capabilities. In particular, processing circuitry 1018 may comprise one or more programmable processors, application-specific integrated circuits, field programmable gate arrays or combinations of these (not shown) adapted to execute instructions. Host computer 1010 further comprises software 1011, which is stored in or accessible by host computer 1010 and executable by processing circuitry 1018. Software 1011 includes host application 1012. Host application 1012 may be operable to provide a service to a remote user, such as UE 1030 connecting via OTT connection 1050 terminating at UE 1030 and host computer 1010. In providing the service to the remote user, host application 1012 may provide user data which is transmitted using OTT connection 1050.

Communication system 1000 further includes base station 1020 provided in a telecommunication system and comprising hardware 1025 enabling it to communicate with host computer 1010 and with UE 1030. Hardware 1025 may include communication interface 1026 for setting up and maintaining a wired or wireless connection with an interface of a different communication device of communication system 1000, as well as radio interface 1027 for setting up and maintaining at least wireless connection 1070 with UE 1030 located in a coverage area (not shown in FIG. 10) served by base station 1020. Communication interface 1026 may be configured to facilitate connection 1060 to host computer 1010. Connection 1060 may be direct or it may pass through a core network (not shown in FIG. 10) of the telecommunication system and/or through one or more intermediate networks outside the telecommunication system. In the embodiment shown, hardware 1025 of base station 1020 further includes processing circuitry 1028, which may comprise one or more programmable processors, application-specific integrated circuits, field programmable gate arrays or combinations of these (not shown) adapted to execute instructions. Base station 1020 further has software 1021 stored internally or accessible via an external connection.

Communication system 1000 further includes UE 1030 already referred to. Its hardware 1035 may include radio interface 1037 configured to set up and maintain wireless connection 1070 with a base station serving a coverage area in which UE 1030 is currently located. Hardware 1035 of UE 1030 further includes processing circuitry 1038, which may comprise one or more programmable processors, application-specific integrated circuits, field programmable gate arrays or combinations of these (not shown) adapted to execute instructions. UE 1030 further comprises software 1031, which is stored in or accessible by UE 1030 and executable by processing circuitry 1038. Software 1031 includes client application 1032. Client application 1032 may be operable to provide a service to a human or non-human user via UE 1030, with the support of host computer 1010. In host computer 1010, an executing host application 1012 may communicate with the executing client application 1032 via OTT connection 1050 terminating at UE 1030 and host computer 1010. In providing the service to the user, client application 1032 may receive request data from host application 1012 and provide user data in response to the request data. OTT connection 1050 may transfer both the request data and the user data. Client application 1032 may interact with the user to generate the user data that it provides.

It is noted that host computer 1010, base station 1020 and UE 1030 illustrated in FIG. 10 may be similar or identical to host computer 930, one of base stations 912a, 912b, 912c and one of UEs 991, 992 of FIG. 9, respectively. This is to say, the inner workings of these entities may be as shown in FIG. 10 and independently, the surrounding network topology may be that of FIG. 9.

In FIG. 10, OTT connection 1050 has been drawn abstractly to illustrate the communication between host computer 1010 and UE 1030 via base station 1020, without explicit reference to any intermediary devices and the precise routing of messages via these devices. Network infrastructure may determine the routing, which it may be configured to hide from UE 1030 or from the service provider operating host computer 1010, or both. While OTT connection 1050 is active, the network infrastructure may further take decisions by which it dynamically changes the routing (e.g., on the basis of load balancing consideration or reconfiguration of the network).

Wireless connection 1070 between UE 1030 and base station 1020 is in accordance with the teachings of the embodiments described throughout this disclosure. One or more of the various embodiments improve the performance of OTT services provided to UE 1030 using OTT connection 1050, in which wireless connection 1070 forms the last segment. More precisely, the teachings of these embodiments may improve the capability of a network node to detect and classify the failure types in the MCG as one of “too late handover”, “too early handover”, and “handover to wrong cell” and thereby provide benefits such as allowing the network node to take an appropriate counter action after the classification of the failure in the MCG so as to avoid further occurrence of such failures, and in some case to optimize CHO candidate cells for MCG mobility and/or CHO configuration parameter(s). Furthermore, by logging the timeConnFailure in the MCG Failure Information, sufficient information can be provided for classifying the failure types and for distinguishing between “too early handover”, “too late handover”, and “handover to wrong cell” cases, thereby making the technique independent from UE history information.

A measurement procedure may be provided for the purpose of monitoring data rate, latency and other factors on which the one or more embodiments improve. There may further be an optional network functionality for reconfiguring OTT connection 1050 between host computer 1010 and UE 1030, in response to variations in the measurement results. The measurement procedure and/or the network functionality for reconfiguring OTT connection 1050 may be implemented in software 1011 and hardware 1015 of host computer 1010 or in software 1031 and hardware 1035 of UE 1030, or both. In embodiments, sensors (not shown) may be deployed in or in association with communication devices through which OTT connection 1050 passes; the sensors may participate in the measurement procedure by supplying values of the monitored quantities exemplified above, or supplying values of other physical quantities from which software 1011, 1031 may compute or estimate the monitored quantities. The reconfiguring of OTT connection 1050 may include message format, retransmission settings, preferred routing etc.; the reconfiguring need not affect base station 1020, and it may be unknown or imperceptible to base station 1020. Such procedures and functionalities may be known and practiced in the art. In certain embodiments, measurements may involve proprietary UE signaling facilitating host computer 1010's measurements of throughput, propagation times, latency and the like. The measurements may be implemented in that software 1011 and 1031 causes messages to be transmitted, in particular empty or ‘dummy’ messages, using OTT connection 1050 while it monitors propagation times, errors etc.

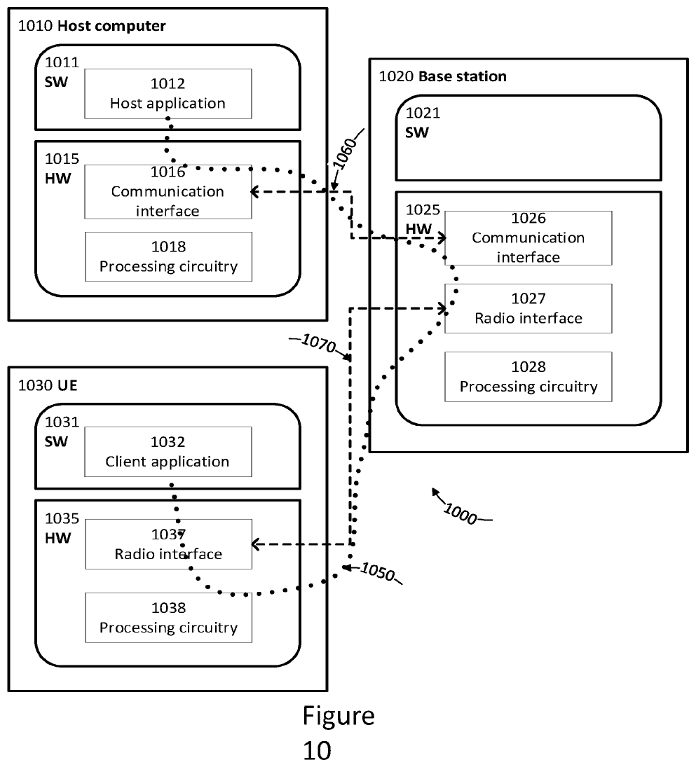

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In step 1110, the host computer provides user data. In substep 1111 (which may be optional) of step 1110, the host computer provides the user data by executing a host application. In step 1120, the host computer initiates a transmission carrying the user data to the UE. In step 1130 (which may be optional), the base station transmits to the UE the user data which was carried in the transmission that the host computer initiated, in accordance with the teachings of the embodiments described throughout this disclosure. In step 1140 (which may also be optional), the UE executes a client application associated with the host application executed by the host computer.

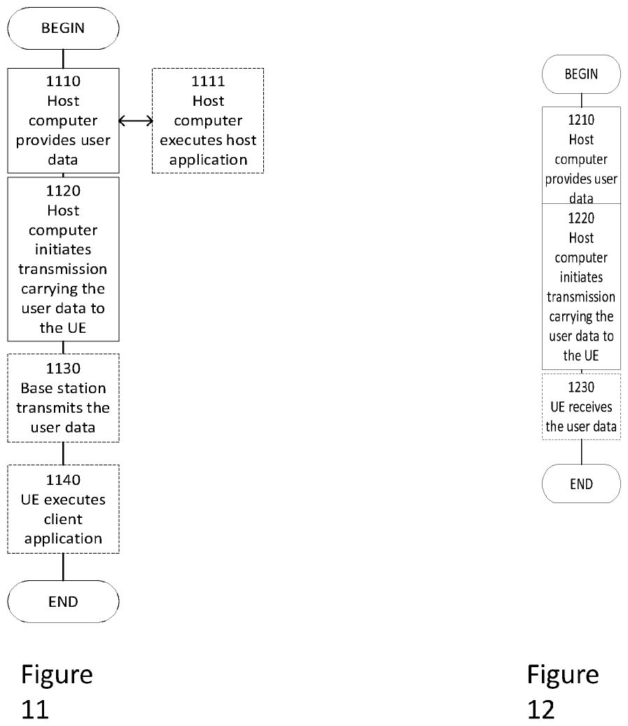

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In step 1210 of the method, the host computer provides user data. In an optional substep (not shown) the host computer provides the user data by executing a host application. In step 1220, the host computer initiates a transmission carrying the user data to the UE. The transmission may pass via the base station, in accordance with the teachings of the embodiments described throughout this disclosure. In step 1230 (which may be optional), the UE receives the user data carried in the transmission.

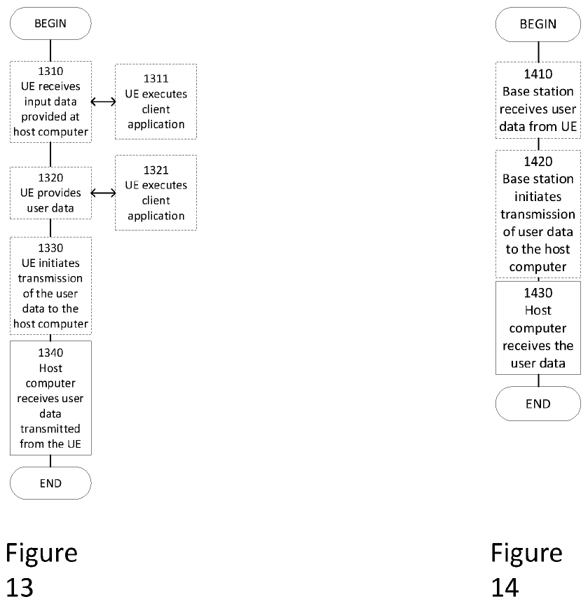

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In step 1310 (which may be optional), the UE receives input data provided by the host computer. Additionally or alternatively, in step 1320, the UE provides user data. In substep 1321 (which may be optional) of step 1320, the UE provides the user data by executing a client application. In substep 1311 (which may be optional) of step 1310, the UE executes a client application which provides the user data in reaction to the received input data provided by the host computer. In providing the user data, the executed client application may further consider user input received from the user. Regardless of the specific manner in which the user data was provided, the UE initiates, in substep 1330 (which may be optional), transmission of the user data to the host computer. In step 1340 of the method, the host computer receives the user data transmitted from the UE, in accordance with the teachings of the embodiments described throughout this disclosure.

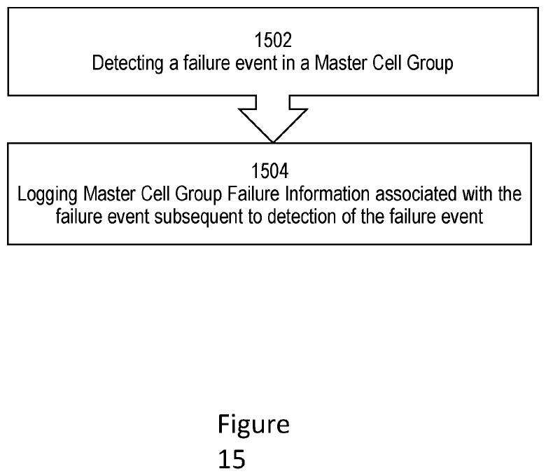

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In step 1410 (which may be optional), in accordance with the teachings of the embodiments described throughout this disclosure, the base station receives user data from the UE. In step 1420 (which may be optional), the base station initiates transmission of the received user data to the host computer. In step 1430 (which may be optional), the host computer receives the user data carried in the transmission initiated by the base station.

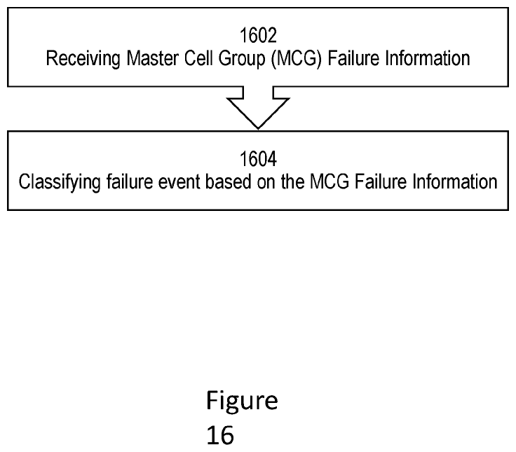

FIG. 15 depicts a method in accordance with particular embodiments, the method begins at step 1502 with detecting a failure event in a Master Cell Group (MCG). The failure event is at least one of a Radio Link Failure (RLF) and a Handover Failure (HOF). Then, the method proceeds to step 1504 with logging MCG Failure Information associated with the failure event, subsequent to the detection of the failure event.

In some embodiments, the method may further comprise transmitting the MCG Failure Information to a base station.

In some embodiments, the MCG Failure Information may further comprise an elapsed time between time of successful execution of the last RRC reconfiguration message associated with the MCG and time of MCG connection failure, the RRC reconfiguration message including reconfiguration with sync and the MCG connection failure.

In some embodiments, the method may further comprise: logging additional information in a Radio Link Failure (RLF) report after a fast MCG link recovery procedure, the additional information indicating an outcome of a fast MCG link recovery procedure, and transmitting the RLF report to the base station.

In some embodiments, the additional information may comprise an indication of whether the wireless device was configured for fast MCG link recovery procedure at the time of the detection of the Radio Link Failure (RLF) event.

In some embodiments, the additional information may comprise an indication that the wireless device performed a fast MCG link recovery procedure and the fast MCG link recovery procedure failed. In these embodiments, the additional information may further comprise at least one of:
cell ID of the cell in which the wireless device attempted reestablishment after T316 expiry,
an indication of whether the cell in which the wireless device attempted reestablishment after T316 expiry was in a list of Conditional Handover (CHO) candidate cells,
an elapsed time between time of the failure event in the MCG and time of reestablishment in a cell after T316 expiry, or an elapsed time between time of execution of the handover that resulted in the Handover Failure (HOF) event and time of establishment in a cell after T316 expiry,
an elapsed time between time of the failure event in the MCG and time of the wireless device entering an idle mode due to no suitable cell found after T316 expiry and possible failure of reestablishment in another cell, and
an indication of T316 expiry.

In some embodiments, the additional information may comprise an indication that the wireless device had a Conditional Handover (CHO) configuration at the time of the detection of the Radio Link Failure (RLF) or the Handover Failure (HOF).

In some embodiments, the additional information may comprise an indication that the wireless device performed a fast MCG link recovery procedure, and that the fast MCG link recovery procedure succeeded. In these embodiments, the additional information may further comprise at least one of:
cell ID of the cell in which the handover (HO) was executed,
an indication of whether the executed handover was in response to a received HO command or in response of a CHO configuration,
an indication of whether the executed handover was successful or not
cell ID of the cell in which the wireless device attempted reestablishment if the executed handover was not successful,
an indication that no suitable cell was found upon failure of the handover towards a target cell and possible failure of reestablishment attempt,
an elapsed time between time of the failure event in the MCG and time of the HO execution before T316 expiry, or an elapsed time between time of execution of the handover that resulted in the HOF event and time of the HO execution before T316 expiry,
an elapsed time between time of the failure event in the MCG and a point in time at which the HO execution is declared successful or completed, or an elapsed time between time of execution of the handover that resulted in the HOF event and a point in time at which the HO execution is declared successful or completed,
an elapsed time between time of the failure event in the MCG and a point in time at which the HO execution is declared unsuccessful, or an elapsed time between time of execution of the handover that resulted in the HOF event and a point in time at which the HO execution is declared unsuccessful,
an elapsed time between time of the failure event in the MCG and time of successful reestablishment after unsuccessful HO execution, or an elapsed time between time of execution of the handover that resulted in the HOF event and time of successful reestablishment after unsuccessful HO execution, and
an elapsed time between time of the failure event in the MCG and time of the wireless device entering an idle mode after unsuccessful reestablishment and unsuccessful HO execution.

In some embodiments, the method may further comprise performing at least one of:
determining that the fast MCG link recovery procedure has failed if T316 expired before the wireless device receives a handover (HO) command or if before the wireless device executes a previously configured CHO configuration; and
determining that the fast MCG link recovery procedure has succeeded if the wireless device has executed handover towards a Primary Cell (PCell), or if the wireless device received a RRC release message before T316 expiry.

In some embodiments, the method may further comprise maintaining the RLF report after handover execution.

In some embodiments, the method may further comprise transmitting wireless device history information of the wireless device to the network node.

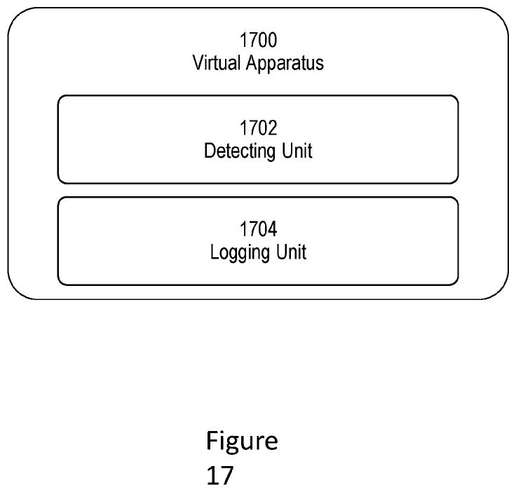

FIG. 16 depicts a method in accordance with particular embodiments, the method begins at step 1602 with receiving, from a wireless device, at least one of: Master Cell Group (MCG) Failure Information and a Radio Link Failure (RLF) report. The MCG Failure Information and/or the RLF report is associated with a failure event, and the failure event is at least one of: a Radio Link Failure (RLF) and a Handover Failure (HOF). Then, the method proceeds to step 1604 with classifying the failure event based on the MCG Failure Information and/or the RLF report.

In some embodiments, classifying the failure event at step 1604 may be based on:
comparison between a radio link quality at the time of the failure event of at least one of: a source cell associated with the failure event and a target cell associated with the failure event and radio link quality of one or more neighbouring cells at the time of the failure event, and
a duration in which the wireless device was dwelling or visiting at a last serving cell before the failure event.

In some embodiments, classifying the failure event at step 1604 may comprise classifying the failure event as one of: late handover, early handover, handover to wrong cell, late conditional handover, early conditional handover, and conditional handover to wrong cell.

In some embodiments, the MCG Failure Information may comprise an elapsed time between time of reception of a last RRC reconfiguration message associated with the MCG and time of MCG connection failure, the Radio Resource Control (RRC) reconfiguration message including reconfiguration with sync.

In some embodiments, the MCG Failure Information may comprise an elapsed time between time of successful execution of the last RRC reconfiguration message associated with the MCG and time of MCG connection failure, the RRC reconfiguration message including reconfiguration with sync.

In some embodiments, classifying the failure event at step 1604 may comprise:
determining, based on the MCG Failure Information and/or the RLF report, whether at the time of the failure event among neighbouring cells there was a cell with higher radio link quality than that of the source cell associated with the failure event;
determining whether a duration in which the wireless device was dwelling or visiting at a last serving cell before the failure event exceeds a predetermined threshold; and
classifying the failure event as a late handover, if it is determined that at the time of the failure event there was a cell with higher radio link quality than that of the source cell associated with the failure event, and that the duration in which the wireless device was dwelling or visiting at a last serving cell before the failure event exceeds the predetermined threshold.

In some embodiments, classifying the failure event at step 1604 may comprise:
determining, based on the MCG Failure Information and/or the RLF report, whether at the time of the failure event among neighbouring cells there was a cell with higher radio link quality than that of the source cell associated with the failure event;
determining whether a duration in which the wireless device was dwelling or visiting at a last serving cell before the failure event exceeds a predetermined threshold; and
determining whether there is an existing Conditional Handover (CHO) configuration for the wireless device; and
classifying the failure event as a late conditional handover, if it is determined that at the time of the failure event there was a cell with higher radio link quality than that of the source cell associated with the failure event, that the duration in which the wireless device was dwelling or visiting at a last serving cell before the failure event exceeds the predetermined threshold, and that there is an existing CHO configuration for the wireless device.

In some embodiments, classifying the failure event at step 1604 may comprise:
determining, based on the MCG Failure Information and/or the RLF report, whether at the time of the failure event the source cell associated with the failure event had higher radio link quality than that of the target cell associated with the failure event and radio link qualities of neighbouring cells;
determining whether a duration in which the wireless device was dwelling or visiting at a last serving cell before the failure event exceeds a predetermined threshold; and
classifying the failure event as early handover, if it is determined that at the time of the failure event the source cell associated with the failure event had higher radio link quality than that of the target cell associated with the failure event and radio link qualities of neighbouring cells, and that the duration in which the wireless device was dwelling or visiting at a last serving cell before the failure event does not exceed the predetermined threshold.

In some embodiments, classifying the failure event at step 1604 may comprise:
determining, based on the MCG Failure Information and/or the RLF report, whether at the time of the failure event the source cell associated with the failure event had higher radio link quality than the of the target cell associated with the failure event and radio link qualities of neighbouring cells;
determining whether a duration in which the wireless device was dwelling or visiting at a last serving cell before the failure event exceeds a predetermined threshold;
determining whether there is an existing Conditional Handover (CHO) configuration for the wireless device; and
classifying the failure event as early conditional handover, if it is determined that at the time of the failure event the source cell associated with the failure event had higher radio link quality than that of the target cell associated with the failure event and radio link qualities of neighbouring cells, that the duration in which the wireless device was dwelling or visiting at a last serving cell before the failure event does not exceed the predetermined threshold, and that there is an existing CHO configuration for the wireless device.

In some embodiments, classifying the failure event at step 1604 may comprise:
determining, based on the MCG Failure Information and/or the RLF report, whether at the time of the failure event among neighbouring cells there was a cell with higher radio link quality than those of the source cell and the target cell associated with the failure event, and whether the cell with higher radio link quality is different from cells configured as part of Secondary Cell Group;
determining whether a duration in which the wireless device was dwelling or visiting at a last serving cell before the failure event exceeds a predetermined threshold; and
classifying the failure event as handover to a wrong cell, if it is determined that at the time of the failure event there was a cell with higher radio link quality than those of the source cell and the target cell associated with the failure event, that the cell with higher link quality is different from cells configured as part of Secondary Cell Group, and that the duration in which the wireless device was dwelling or visiting at a last serving cell before the failure event does not exceed the predetermined threshold.

In some embodiments, classifying the failure event at step 1604 may comprise:
determining, based on the MCG Failure Information and/or the RLF report, whether at the time of the failure event among neighbouring cells there was a cell with higher radio link quality than those of the source cell and the target cell associated with the failure event, and whether the cell with higher radio link quality is different from cells configured as part of Secondary Cell Group;
determining whether a duration in which the wireless device was dwelling or visiting at a last serving cell before the failure event exceeds a predetermined threshold;
determining whether there is an existing Conditional Handover (CHO) configuration for the wireless device; and
classifying the failure event as conditional handover to a wrong cell, if it is determined that at the time of the failure event there was a cell with higher radio link quality than those of the source cell and the target cell associated with the failure event, that the cell with higher radio link quality is different from cells configured as part of Secondary Cell Group, that the duration in which the wireless device was dwelling or visiting at a last serving cell before the failure event does not exceed the predetermined threshold, and that there is an existing CHO configuration for the wireless device.

In some embodiments, determining whether the duration in which the wireless device was dwelling or visiting at a last serving cell before the failure event exceeds a predetermined threshold may be based on the elapsed time between time of reception of a last RRC reconfiguration message associated with the MCG and time of MCG connection failure, and/or the elapsed time between time of successful execution of the last RRC reconfiguration message associated with the MCG and time of MCG connection failure.

In some embodiments, the method may further comprise receiving wireless device history information from the wireless device. In these embodiments, determining whether the duration in which the wireless device was dwelling or visiting at a last serving cell before the failure event exceeds a predetermined threshold may be based on the wireless device history information.

In some embodiments, classifying the failure event at step 1604 may comprise:
determining, based on the MCG Failure Information, that T310 expiry is the reason of the failure event;
determining that no cell measurement is available in the MCG Failure Information;
determining that the base station sends RRC reconfiguration messages including reconfiguration with sync to the wireless device; and
classifying the failure event as late handover.

In some embodiments, classifying the failure event at step 1604 may comprise:
determining, based on the MCG Failure Information, that T310 expiry is the reason of the failure event;
determining that no cell measurement is available in the MCG Failure Information;
determining that the base station sends RRC reconfiguration messages including reconfiguration with sync to the wireless device;
determining that there is an existing Conditional Handover (CHO) configuration for the wireless device; and
classifying the failure event as late conditional handover.

In some embodiments, the method may further comprise modifying, based on the classification of the failure event, at least one of: a list of the prepared cells associated with the CHO configuration, and one or more conditional handover related parameters.

In some embodiments where the method comprises receiving a RLF report from the wireless device, the method may further comprise determining, based on the RLF report, whether the failure event was followed by a fast MCG link recovery procedure. If it is determined that the failure event was followed by a fast MCG link recovery procedure, the method may further comprise: determining whether the fast MCG link recovery procedure was followed by a handover execution triggered by reception of a RRC reconfiguration message including reconfiguration with sync or trigged by execution of a configured CHO, or whether the fast MCF link recovery procedure was followed by a reestablishment initiated by the wireless device in absence of triggering of an HO execution.

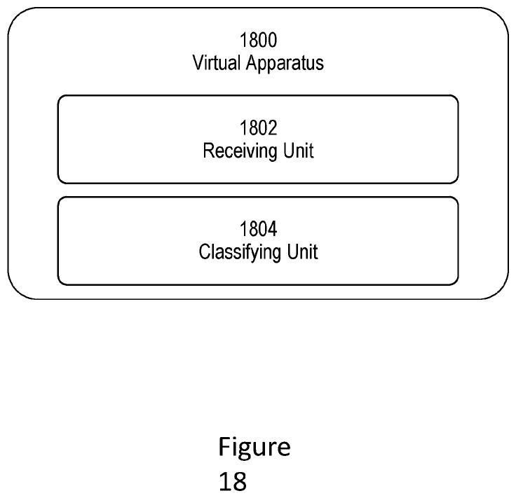

FIG. 17 illustrates a schematic block diagram of an apparatus 1700 in a wireless network (for example, the wireless network shown in FIG. 6). The apparatus may be implemented in a wireless device or network node (e.g., wireless device 610 or network node 660 shown in FIG. 6). Apparatus 1700 is operable to carry out the example method described with reference to FIG. 15 and possibly any other processes or methods disclosed herein. It is also to be understood that the method of FIG. 15 is not necessarily carried out solely by apparatus 1700. At least some operations of the method can be performed by one or more other entities.

Virtual Apparatus 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause detecting unit 1702, logging unit 1704, and any other suitable units of apparatus 1700 to perform corresponding functions according one or more embodiments of the present disclosure.

As illustrated in FIG. 17, apparatus 1700 includes detecting unit 1702 and logging unit 1704. Detecting unit 1702 is configured to detect a failure event in a Master Cell Group (MCG), the failure event being at least one of a Radio Link Failure (RLF) and a Handover Failure (HOF). Logging unit 1704 is configured to log MCG Failure Information associated with the failure event subsequent to detection of the failure event. The MCG Failure Information comprises an elapsed time between time of reception of a last Radio Resource Control (RRC) reconfiguration message associated with the MCG and time of MCG connection failure, the RRC reconfiguration message including reconfiguration with sync. In some embodiments, apparatus 1700 may further comprise transmitting unit configured to transmit the MCG Failure Information to a base station.

In some embodiments, the MCG Failure Information may further comprise an elapsed time between time of successful execution of the last RRC reconfiguration message associated with the MCG and time of MCG connection failure, the RRC reconfiguration message including reconfiguration with sync.

In some embodiments, logging unit 1704 may be further configured to log additional information in a Radio Link Failure (RLF) report after a fast MCG link recovery procedure, the additional information indicating an outcome of a fast MCG link recovery procedure. In these embodiments, apparatus 1700 may further comprise transmitting unit configured to transmit the RLF report to the base station.

In some embodiments, the additional information may comprise an indication of whether the wireless device was configured for fast MCG link recovery procedure at the time of the detection of the Radio Link Failure (RLF) event.

In some embodiments, the additional information may comprise an indication that the wireless device performed a fast MCG link recovery procedure and the fast MCG link recovery procedure failed. In these embodiments, the additional information may further comprise at least one of:
cell ID of the cell in which the wireless device attempted reestablishment after T316 expiry,
an indication of whether the cell in which the wireless device attempted reestablishment after T316 expiry was in a list of Conditional Handover (CHO) candidate cells,
an elapsed time between time of the failure event in the MCG and time of reestablishment in a cell after T316 expiry, or an elapsed time between time of execution of the handover that resulted in the Handover Failure (HOF) event and time of establishment in a cell after T316 expiry,
an elapsed time between time of the failure event in the MCG and time of the wireless device entering an idle mode due to no suitable cell found after T316 expiry and possible failure of reestablishment in another cell, and
an indication of T316 expiry.

In some embodiments, the additional information may comprise an indication that the wireless device had a Conditional Handover (CHO) configuration at the time of the detection of the Radio Link Failure (RLF) or the Handover Failure (HOF).

In some embodiments, the additional information may comprise an indication that the wireless device performed a fast MCG link recovery procedure, and that the fast MCG link recovery procedure succeeded. In these embodiments, the additional information may further comprise at least one of:
cell ID of the cell in which the handover (HO) was executed,
an indication of whether the executed handover was in response to a received HO command or in response of a CHO configuration,
an indication of whether the executed handover was successful or not
cell ID of the cell in which the wireless device attempted reestablishment if the executed handover was not successful,
an indication that no suitable cell was found upon failure of the handover towards a target cell and possible failure of reestablishment attempt,
an elapsed time between time of the failure event in the MCG and time of the HO execution before T316 expiry, or an elapsed time between time of execution of the handover that resulted in the HOF event and time of the HO execution before T316 expiry,
an elapsed time between time of the failure event in the MCG and a point in time at which the HO execution is declared successful or completed, or an elapsed time between time of execution of the handover that resulted in the HOF event and a point in time at which the HO execution is declared successful or completed,
an elapsed time between time of the failure event in the MCG and a point in time at which the HO execution is declared unsuccessful, or an elapsed time between time of execution of the handover that resulted in the HOF event and a point in time at which the HO execution is declared unsuccessful,
an elapsed time between time of the failure event in the MCG and time of successful reestablishment after unsuccessful HO execution, or an elapsed time between time of execution of the handover that resulted in the HOF event and time of successful reestablishment after unsuccessful HO execution, and
an elapsed time between time of the failure event in the MCG and time of the wireless device entering an idle mode after unsuccessful reestablishment and unsuccessful HO execution.

In some embodiments, apparatus 1700 may further comprise determining unit configured to determine that the fast MCG link recovery procedure has failed if T316 expired before the wireless device receives a handover (HO) command or if before the wireless device executes a previously configured CHO configuration, and to determine that the fast MCG link recovery procedure has succeeded if the wireless device has executed handover towards a Primary Cell (PCell), or if the wireless device received a RRC release message before T316 expiry.

In some embodiments, apparatus 1700 may further comprise maintaining unit configured to maintain the RLF report after handover execution.

In some embodiments, apparatus 1700 may further comprise transmitting unit configured to transmit wireless device history information of the wireless device to the network node.

FIG. 18 illustrates a schematic block diagram of an apparatus 1800 in a wireless network (for example, the wireless network shown in FIG. 6). The apparatus may be implemented in a wireless device or network node (e.g., wireless device 610 or network node 660 shown in FIG. 6). Apparatus 1800 is operable to carry out the example method described with reference to FIG. 16 and possibly any other processes or methods disclosed herein. It is also to be understood that the method of FIG. 16 is not necessarily carried out solely by apparatus 1800. At least some operations of the method can be performed by one or more other entities.

Virtual Apparatus 1800 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 1802, classifying unit 1804, and any other suitable units of apparatus 1700 to perform corresponding functions according one or more embodiments of the present disclosure.

As illustrated in FIG. 18, apparatus 1700 includes receiving unit 1802 and classifying unit 1804. Receiving unit 1802 is configured to receive, from a wireless device, at least one of: Master Cell Group (MCG) Failure Information and a Radio Link Failure (RLF) report, the MCG Failure Information and/or the RLF report being associated with a failure event, and the failure event being at least one of: a Radio Link Failure (RLF) and a Handover Failure (HOF). Classifying unit 1804 is configured to classify the failure event based on the MCG Failure Information and/or the RLF report.

In some embodiments, classifying unit 1804 may be configured to classify the failure event based on:
comparison between a radio link quality at the time of the failure event of at least one of: a source cell associated with the failure event and a target cell associated with the failure event and radio link quality of one or more neighbouring cells at the time of the failure event, and
a duration in which the wireless device was dwelling or visiting at a last serving cell before the failure event.

In some embodiments, classifying unit 1804 may be configured to classify the failure event by classifying the failure event as one of: late handover, early handover, handover to wrong cell, late conditional handover, early conditional handover, and conditional handover to wrong cell.

In some embodiments, the MCG Failure Information may comprise an elapsed time between time of reception of a last RRC reconfiguration message associated with the MCG and time of MCG connection failure, the Radio Resource Control (RRC) reconfiguration message including reconfiguration with sync.

In some embodiments, the MCG Failure Information may comprise an elapsed time between time of successful execution of the last RRC reconfiguration message associated with the MCG and time of MCG connection failure, the RRC reconfiguration message including reconfiguration with sync.

In some embodiments, classifying unit 1804 may be configured to classify the failure event by:
determining, based on the MCG Failure Information and/or the RLF report, whether at the time of the failure event among neighbouring cells there was a cell with higher radio link quality than that of the source cell associated with the failure event;
determining whether a duration in which the wireless device was dwelling or visiting at a last serving cell before the failure event exceeds a predetermined threshold; and
classifying the failure event as a late handover, if it is determined that at the time of the failure event there was a cell with higher radio link quality than that of the source cell associated with the failure event, and that the duration in which the wireless device was dwelling or visiting at a last serving cell before the failure event exceeds the predetermined threshold.

In some embodiments, classifying unit 1804 may be configured to classify the failure event by:
determining, based on the MCG Failure Information and/or the RLF report, whether at the time of the failure event among neighbouring cells there was a cell with higher radio link quality than that of the source cell associated with the failure event;
determining whether a duration in which the wireless device was dwelling or visiting at a last serving cell before the failure event exceeds a predetermined threshold; and
determining whether there is an existing Conditional Handover (CHO) configuration for the wireless device; and
classifying the failure event as a late conditional handover, if it is determined that at the time of the failure event there was a cell with higher radio link quality than that of the source cell associated with the failure event, that the duration in which the wireless device was dwelling or visiting at a last serving cell before the failure event exceeds the predetermined threshold, and that there is an existing CHO configuration for the wireless device.

In some embodiments, classifying unit 1804 may be configured to classify the failure event by:
determining, based on the MCG Failure Information and/or the RLF report, whether at the time of the failure event the source cell associated with the failure event had higher radio link quality than that of the target cell associated with the failure event and radio link qualities of neighbouring cells;
determining whether a duration in which the wireless device was dwelling or visiting at a last serving cell before the failure event exceeds a predetermined threshold; and
classifying the failure event as early handover, if it is determined that at the time of the failure event the source cell associated with the failure event had higher radio link quality than that of the target cell associated with the failure event and radio link qualities of neighbouring cells, and that the duration in which the wireless device was dwelling or visiting at a last serving cell before the failure event does not exceed the predetermined threshold.

In some embodiments, classifying unit 1804 may be configured to classify the failure event by:
determining, based on the MCG Failure Information and/or the RLF report, whether at the time of the failure event the source cell associated with the failure event had higher radio link quality than the of the target cell associated with the failure event and radio link qualities of neighbouring cells;
determining whether a duration in which the wireless device was dwelling or visiting at a last serving cell before the failure event exceeds a predetermined threshold;
determining whether there is an existing Conditional Handover (CHO) configuration for the wireless device; and
classifying the failure event as early conditional handover, if it is determined that at the time of the failure event the source cell associated with the failure event had higher radio link quality than that of the target cell associated with the failure event and radio link qualities of neighbouring cells, that the duration in which the wireless device was dwelling or visiting at a last serving cell before the failure event does not exceed the predetermined threshold, and that there is an existing CHO configuration for the wireless device.

In some embodiments, classifying unit 1804 may be configured to classify the failure event by:
determining, based on the MCG Failure Information and/or the RLF report, whether at the time of the failure event among neighbouring cells there was a cell with higher radio link quality than those of the source cell and the target cell associated with the failure event, and whether the cell with higher radio link quality is different from cells configured as part of Secondary Cell Group;
determining whether a duration in which the wireless device was dwelling or visiting at a last serving cell before the failure event exceeds a predetermined threshold; and
classifying the failure event as handover to a wrong cell, if it is determined that at the time of the failure event there was a cell with higher radio link quality than those of the source cell and the target cell associated with the failure event, that the cell with higher link quality is different from cells configured as part of Secondary Cell Group, and that the duration in which the wireless device was dwelling or visiting at a last serving cell before the failure event does not exceed the predetermined threshold.

In some embodiments, classifying unit 1804 may be configured to classify the failure event by:
determining, based on the MCG Failure Information and/or the RLF report, whether at the time of the failure event among neighbouring cells there was a cell with higher radio link quality than those of the source cell and the target cell associated with the failure event, and whether the cell with higher radio link quality is different from cells configured as part of Secondary Cell Group;
determining whether a duration in which the wireless device was dwelling or visiting at a last serving cell before the failure event exceeds a predetermined threshold;
determining whether there is an existing Conditional Handover (CHO) configuration for the wireless device; and
classifying the failure event as conditional handover to a wrong cell, if it is determined that at the time of the failure event there was a cell with higher radio link quality than those of the source cell and the target cell associated with the failure event, that the cell with higher radio link quality is different from cells configured as part of Secondary Cell Group, that the duration in which the wireless device was dwelling or visiting at a last serving cell before the failure event does not exceed the predetermined threshold, and that there is an existing CHO configuration for the wireless device.

In some embodiments, classifying unit 1804 may be configured to determine whether the duration in which the wireless device was dwelling or visiting at a last serving cell before the failure event exceeds a predetermined threshold based on the elapsed time between time of reception of a last RRC reconfiguration message associated with the MCG and time of MCG connection failure, and/or the elapsed time between time of successful execution of the last RRC reconfiguration message associated with the MCG and time of MCG connection failure.

In some embodiments, receiving unit 1802 may be further configured to receive wireless device history information from the wireless device. In these embodiments, classifying unit 1804 may be configured to determine whether the duration in which the wireless device was dwelling or visiting at a last serving cell before the failure event exceeds a predetermined threshold based on the wireless device history information.

In some embodiments, classifying unit 1804 may be configured to classify the failure event by:
determining, based on the MCG Failure Information, that T310 expiry is the reason of the failure event;
determining that no cell measurement is available in the MCG Failure Information;
determining that the base station sends RRC reconfiguration messages including reconfiguration with sync to the wireless device; and
classifying the failure event as late handover.

In some embodiments, classifying unit 1804 may be configured to classify the failure event by:
determining, based on the MCG Failure Information, that T310 expiry is the reason of the failure event;
determining that no cell measurement is available in the MCG Failure Information;
determining that the base station sends RRC reconfiguration messages including reconfiguration with sync to the wireless device;
determining that there is an existing Conditional Handover (CHO) configuration for the wireless device; and
classifying the failure event as late conditional handover.

In some embodiments, apparatus 1800 may further comprise modifying unit configured to modify, based on the classification of the failure event, at least one of: a list of the prepared cells associated with the CHO configuration, and one or more conditional handover related parameters.

In some embodiments, receiving unit 1802 may be further configured to receive a RLF report from the wireless device. In these embodiments, apparatus 1800 may further comprise determining unit configured to determine, based on the RLF report, whether the failure event was followed by a fast MCG link recovery procedure. If it is determined by determining unit that the failure event was followed by a fast MCG link recovery procedure, determining unit may be further configured to determine whether the fast MCG link recovery procedure was followed by a handover execution triggered by reception of a RRC reconfiguration message including reconfiguration with sync or trigged by execution of a configured CHO, or whether the fast MCF link recovery procedure was followed by a reestablishment initiated by the wireless device in absence of triggering of an HO execution.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The following numbered embodiments provide additional information on the disclosure:
1. A method performed by a wireless device, the method comprising:
   detecting a failure event in a Master Cell Group (MCG), wherein the failure event is at least one of a Radio Link Failure (RLF) and a Handover Failure (HOF); and
   logging Master Cell Group (MCG) Failure Information associated with the failure event subsequent to detection of the failure event, wherein the MCG Failure Information comprises an elapsed time between time of reception of a last Radio Resource Control (RRC) reconfiguration message associated with the MCG and time of MCG connection failure, the RRC reconfiguration message including reconfiguration with sync.
2. The method of embodiment 1, further comprising transmitting the MCG Failure Information to a base station.
3. The method of any of embodiments 1 and 2, wherein the MCG Failure Information further comprises an elapsed time between time of successful execution of the last RRC reconfiguration message associated with the MCG and time of MCG connection failure, the RRC reconfiguration message including reconfiguration with sync.
4. The method of any of embodiments 1 to 3, further comprising:
   logging additional information in a Radio Link Failure (RLF) report after a fast MCG link recovery procedure, wherein the additional information indicates an outcome of the fast MCG link recovery procedure; and
   transmitting the RLF report to the base station.
5. The method of embodiment 4, wherein the additional information comprises an indication of whether the wireless device was configured for fast MCG link recovery procedure at the time of the detection of the Radio Link Failure (RLF) event.
6. The method of embodiment 4 or embodiment 5, wherein the additional information comprises an indication that the wireless device performed a fast MCG link recovery procedure and the fast MCG link recovery procedure failed.
7. The method of embodiment 6, wherein the additional information further comprises at least one of:
   cell ID of the cell in which the wireless device attempted reestablishment after T316 expiry,
   an indication of whether the cell in which the wireless device attempted reestablishment after T316 expiry was in a list of Conditional Handover (CHO) candidate cells,
   an elapsed time between time of the failure event in the MCG and time of reestablishment in a cell after T316 expiry, or an elapsed time between time of execution of the handover that resulted in the Handover Failure (HOF) event and time of establishment in a cell after T316 expiry,
   an elapsed time between time of the failure event in the MCG and time the wireless device entering an idle mode due to no suitable cell found after T316 expiry and possible failure of reestablishment in another cell, and
   an indication of T316 expiry.
8. The method of any of embodiments 4 to 7, wherein the additional information comprises an indication that the wireless device had a Conditional Handover (CHO) configuration at the time of the detection of the Radio Link Failure (RLF) or the Handover Failure (HOF).
9. The method of embodiment 4, embodiment 5, or embodiment 8 when dependent on embodiments 4 or 5, wherein the additional information comprises an indication that the wireless device performed a fast MCG link recovery procedure, and that the fast MCG link recovery procedure succeeded.
10. The method of the embodiment 9, wherein the additional information further comprises at least one of:
   cell ID of the cell in which the handover (HO) was executed,
   an indication of whether the executed handover was in response to a received HO command or in response of a CHO configuration,
   an indication of whether the executed handover was successful or not
   cell ID of the cell in which the wireless device attempted reestablishment if the executed handover was not successful,
   an indication that no suitable cell was found upon failure of the handover towards a target cell and possible failure of reestablishment attempt,
   an elapsed time between time of the failure event in the MCG and time of the HO execution before T316 expiry, or an elapsed time between time of execution of the handover that resulted in the HOF event and time of the HO execution before T316 expiry,
   an elapsed time between time of the failure event in the MCG and a point in time at which the HO execution is declared successful or completed, or an elapsed time between time of execution of the handover that resulted in the HOF event and a point in time at which the HO execution is declared successful or completed,
   an elapsed time between time of the failure event in the MCG and a point in time at which the HO execution is declared unsuccessful, or an elapsed time between time of execution of the handover that resulted in the HOF event and a point in time at which the HO execution is declared unsuccessful,
   an elapsed time between time of the failure event in the MCG and time of successful reestablishment after unsuccessful HO execution, or an elapsed time between time of execution of the handover that resulted in the HOF event and time of successful reestablishment after unsuccessful HO execution, and
   an elapsed time between time of the failure event in the MCG and time of the wireless device entering an idle mode after unsuccessful reestablishment and unsuccessful HO execution.
11. The method of any of embodiments 5 to 10, further comprising performing at least one of:
   determining that the fast MCG link recovery procedure has failed if T316 expired before the wireless device receives a handover (HO) command or if before the wireless device executes a previously configured CHO configuration; and
   determining that the fast MCG link recovery procedure has succeeded if the wireless device has executed handover towards a Primary Cell (PCell), or if the wireless device received a RRC release message before T316 expiry.
12. The method of any of embodiments 4 to 11, further comprising maintaining the RLF report after handover execution.
13. The method of any of embodiments 1 to 12, further comprising transmitting wireless device history information of the wireless device to the network node.
14. The method of any of embodiments 1 to 13, further comprising:
   providing user data; and
   forwarding the user data to a host computer via the transmission to the base station.
15. A method performed by a base station for classifying mobility failure, the method comprising:
   receiving, from a wireless device, at least one of: Master Cell Group (MCG) Failure Information and a Radio Link Failure (RLF) report, wherein the MCG Failure Information and/or the RLF report is associated with a failure event, and the failure event is at least one of: a Radio Link Failure (RLF) and a Handover Failure (HOF); and
   classifying the failure event based on the MCG Failure Information and/or the RLF report.
16. The method of embodiment 15, wherein classifying the failure event is based on:
   comparison between a radio link quality at the time of the failure event of at least one of: a source cell associated with the failure event and a target cell associated with the failure event and radio link quality of one or more neighboring cells at the time of the failure event, and
   a duration in which the wireless device was dwelling or visiting at a last serving cell before the failure event.
17. The method of any of embodiments 15 and 16, wherein classifying the failure event comprises classifying the failure event as one of: late handover, early handover, handover to wrong cell, late conditional handover, early conditional handover, and conditional handover to wrong cell.
18. The method of any of embodiments 15 to 17, wherein the MCG Failure Information comprises an elapsed time between time of reception of a last RRC reconfiguration message associated with the MCG and time of MCG connection failure, the Radio Resource Control (RRC) reconfiguration message including reconfiguration with sync.
19. The method of any of embodiments 15 to 18, wherein the MCG Failure Information comprises an elapsed time between time of successful execution of the last RRC reconfiguration message associated with the MCG and time of MCG connection failure, the RRC reconfiguration message including reconfiguration with sync.
20. The method of any of embodiments 15 to 19, wherein classifying the failure event comprises:
   determining, based on the MCG Failure Information and/or the RLF report, whether at the time of the failure event among neighboring cells there was a cell with higher radio link quality than that of the source cell associated with the failure event;
   determining whether a duration in which the wireless device was dwelling or visiting at a last serving cell before the failure event exceeds a predetermined threshold; and
classifying the failure event as a late handover, if it is determined that at the time of the failure event there was a cell with higher radio link quality than that of the source cell associated with the failure event, and that the duration in which the wireless device was dwelling or visiting at a last serving cell before the failure event exceeds the predetermined threshold.
21. The method of any of embodiments 15 to 20, wherein classifying the failure event comprises:
   determining, based on the MCG Failure Information and/or the RLF report, whether at the time of the failure event among neighboring cells there was a cell with higher radio link quality than that of the source cell associated with the failure event;
   determining whether a duration in which the wireless device was dwelling or visiting at a last serving cell before the failure event exceeds a predetermined threshold; and
   determining whether there is an existing Conditional Handover (CHO) configuration for the wireless device; and
   classifying the failure event as a late conditional handover, if it is determined that at the time of the failure event there was a cell with higher radio link quality than that of the source cell associated with the failure event, that the duration in which the wireless device was dwelling or visiting at a last serving cell before the failure event exceeds the predetermined threshold, and that there is an existing CHO configuration for the wireless device.
22. The method of any of embodiments 15 to 21, wherein classifying the failure event comprises:
   determining, based on the MCG Failure Information and/or the RLF report, whether at the time of the failure event the source cell associated with the failure event had higher radio link quality than that of the target cell associated with the failure event and radio link qualities of neighboring cells;
   determining whether a duration in which the wireless device was dwelling or visiting at a last serving cell before the failure event exceeds a predetermined threshold; and
   classifying the failure event as early handover, if it is determined that at the time of the failure event the source cell associated with the failure event had higher radio link quality than that of the target cell associated with the failure event and radio link qualities of neighboring cells, and that the duration in which the wireless device was dwelling or visiting at a last serving cell before the failure event does not exceed the predetermined threshold.
23. The method of any of embodiments 15 to 22, wherein classifying the failure event comprises:
   determining, based on the MCG Failure Information and/or the RLF report, whether at the time of the failure event the source cell associated with the failure event had higher radio link quality than the of the target cell associated with the failure event and radio link qualities of neighboring cells;
   determining whether a duration in which the wireless device was dwelling or visiting at a last serving cell before the failure event exceeds a predetermined threshold;
   determining whether there is an existing Conditional Handover (CHO) configuration for the wireless device; and
   classifying the failure event as early conditional handover, if it is determined that at the time of the failure event the source cell associated with the failure event had higher radio link quality than that of the target cell associated with the failure event and radio link qualities of neighboring cells, that the duration in which the wireless device was dwelling or visiting at a last serving cell before the failure event does not exceed the predetermined threshold, and that there is an existing CHO configuration for the wireless device.
24. The method of any of embodiments 15 to 23, wherein classifying the failure event comprises:
   determining, based on the MCG Failure Information and/or the RLF report, whether at the time of the failure event among neighboring cells there was a cell with higher radio link quality than those of the source cell and the target cell associated with the failure event, and whether the cell with higher radio link quality is different from cells configured as part of Secondary Cell Group;
   determining whether a duration in which the wireless device was dwelling or visiting at a last serving cell before the failure event exceeds a predetermined threshold; and
   classifying the failure event as handover to a wrong cell, if it is determined that at the time of the failure event there was a cell with higher radio link quality than those of the source cell and the target cell associated with the failure event, that the cell with higher link quality is different from cells configured as part of Secondary Cell Group, and that the duration in which the wireless device was dwelling or visiting at a last serving cell before the failure event does not exceed the predetermined threshold.
25. The method of any of embodiments 15 to 24, wherein classifying the failure event comprises:
   determining, based on the MCG Failure Information and/or the RLF report, whether at the time of the failure event among neighboring cells there was a cell with higher radio link quality than those of the source cell and the target cell associated with the failure event, and whether the cell with higher radio link quality is different from cells configured as part of Secondary Cell Group;
   determining whether a duration in which the wireless device was dwelling or visiting at a last serving cell before the failure event exceeds a predetermined threshold;
   determining whether there is an existing Conditional Handover (CHO) configuration for the wireless device; and
   classifying the failure event as conditional handover to a wrong cell, if it is determined that at the time of the failure event there was a cell with higher radio link quality than those of the source cell and the target cell associated with the failure event, that the cell with higher radio link quality is different from cells configured as part of Secondary Cell Group, that the duration in which the wireless device was dwelling or visiting at a last serving cell before the failure event does not exceed the predetermined threshold, and that there is an existing CHO configuration for the wireless device.
26. The method of any of embodiments 20 to 25 when dependent on embodiments 19 or 20, wherein determining whether the duration in which the wireless device was dwelling or visiting at a last serving cell before the failure event exceeds a predetermined threshold is based on the elapsed time between time of reception of a last RRC reconfiguration message associated with the MCG and time of MCG connection failure, and/or the elapsed time between time of successful execution of the last RRC reconfiguration message associated with the MCG and time of MCG connection failure.
27. The method of any of embodiments 20 to 26, further comprising receiving wireless device history information from the wireless device, wherein determining whether the duration in which the wireless device was dwelling or visiting at a last serving cell before the failure event exceeds a predetermined threshold is based on the wireless device history information.
28. The method of any of embodiments 15 to 27, wherein classifying the failure event comprises:
   determining, based on the MCG Failure Information, that T310 expiry is the reason of the failure event;
   determining that no cell measurement is available in the MCG Failure Information;
   determining that the base station sends RRC reconfiguration messages including reconfiguration with sync to the wireless device; and
   classifying the failure event as late handover.
29. The method of any of embodiments 15 to 28, wherein classifying the failure event comprises:
   determining, based on the MCG Failure Information, that T310 expiry is the reason of the failure event;
   determining that no cell measurement is available in the MCG Failure Information;
   determining that the base station sends RRC reconfiguration messages including reconfiguration with sync to the wireless device;
   determining that there is an existing Conditional Handover (CHO) configuration for the wireless device; and
   classifying the failure event as late conditional handover.
30. The method of any of embodiments 15 to 29, further comprising modifying, based on the classification of the failure event, at least one of: a list of the prepared cells associated with the CHO configuration, and one or more conditional handover related parameters.
31. The method of any of embodiments 15 to 30, wherein the method comprises receiving a RLF report from the wireless device, and the method further comprising:
   determining, based on the RLF report, whether the failure event was followed by a fast MCG link recovery procedure.
32. The method of embodiment 31, wherein if it is determined that the failure event was followed by a fast MCG link recovery procedure, the method further comprises:
   determining whether the fast MCG link recovery procedure was followed by a handover execution triggered by reception of a RRC reconfiguration message including reconfiguration with sync or trigged by execution of a configured CHO, or whether the fast MCF link recovery procedure was followed by a reestablishment initiated by the wireless device in absence of triggering of an HO execution.
33. The method of any of the previous embodiments, further comprising:
   obtaining user data; and
   forwarding the user data to a host computer or a wireless device.
34. A wireless device, the wireless device comprising:
   processing circuitry configured to perform any of the steps of any of embodiments 1 to 14; and
   power supply circuitry configured to supply power to the wireless device.
35. A base station for classifying mobility failure, the base station comprising:
   processing circuitry configured to perform any of the steps of any of embodiments 15 to 33;
   power supply circuitry configured to supply power to the base station.
36. A user equipment (UE), the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of embodiments 1 to 14;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
37. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of embodiments 15 to 33.
38. The communication system of embodiment 37 further including the base station.
39. The communication system of any of embodiments 37 and 38, further including the UE, wherein the UE is configured to communicate with the base station.
40. The communication system of any of embodiments 37 to 39, wherein:
   the processing circuitry of the host computer is configured to execute a host application, thereby providing the user data; and
   the UE comprises processing circuitry configured to execute a client application associated with the host application.
41. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of embodiments 15 to 33.
42. The method of embodiment 41, further comprising, at the base station, transmitting the user data.
43. The method of any of embodiments 41 and 42, wherein the user data is provided at the host computer by executing a host application, the method further comprising, at the UE, executing a client application associated with the host application.
44. A user equipment (UE) configured to communicate with a base station, the UE comprising a radio interface and processing circuitry configured to perform the steps of any of embodiments 41 to 43.
45. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of embodiments 1 to 14.
46. The communication system of embodiment 45, wherein the cellular network further includes a base station configured to communicate with the UE.
47. The communication system any of embodiments 45 and 46, wherein:
   the processing circuitry of the host computer is configured to execute a host application, thereby providing the user data; and
   the UE's processing circuitry is configured to execute a client application associated with the host application.
48. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of embodiments 1 to 14.
49. The method of embodiment 48, further comprising at the UE, receiving the user data from the base station.
50. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of embodiments 1 to 14.
51. The communication system of embodiment 50, further including the UE.
52. The communication system of any of embodiments 50 and 51, further including the base station, wherein the base station comprises a radio interface configured to communicate with the UE and a communication interface configured to forward to the host computer the user data carried by a transmission from the UE to the base station.
53. The communication system of any of embodiments 50 to 52, wherein:
   the processing circuitry of the host computer is configured to execute a host application; and
   the UE's processing circuitry is configured to execute a client application associated with the host application, thereby providing the user data.
54. The communication system any of embodiments 50 to 53, wherein:
   the processing circuitry of the host computer is configured to execute a host application, thereby providing request data; and
   the UE's processing circuitry is configured to execute a client application associated with the host application, thereby providing the user data in response to the request data.
55. A method implemented in a communication system including a host computer, a base station and a user equipment (UE), the method comprising:
   at the host computer, receiving user data transmitted to the base station from the UE, wherein the UE performs any of the steps of any of embodiments 1 to 14.
56. The method of embodiment 55, further comprising, at the UE, providing the user data to the base station.
57. The method of any of embodiments 55 and 56, further comprising:
   at the UE, executing a client application, thereby providing the user data to be transmitted; and
   at the host computer, executing a host application associated with the client application.
58. The method of any of embodiments 55 to 57, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
59. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of embodiments 15 to 33.
60. The communication system of embodiment 59 further including the base station.
61. The communication system of any of embodiments 59 ad 60, further including the UE, wherein the UE is configured to communicate with the base station.
62. The communication system of any of embodiments 59 to 61, wherein:
   the processing circuitry of the host computer is configured to execute a host application;
   the UE is configured to execute a client application associated with the host application, thereby providing the user data to be received by the host computer.
63. A method implemented in a communication system including a host computer, a base station and a user equipment (UE), the method comprising:
   at the host computer, receiving, from the base station, user data originating from a transmission which the base station has received from the UE, wherein the UE performs any of the steps of any of embodiments 1 to 14.
64. The method of embodiment 63, further comprising at the base station, receiving the user data from the UE.
65. The method of any of embodiments 63 and 64, further comprising at the base station, initiating a transmission of the received user data to the host computer.

1-29. (canceled)

30. A method performed by a wireless device, the method comprising:
detecting a failure event in a Master Cell Group (MCG), wherein the failure event is at least one of a Radio Link Failure (RLF) and a Handover Failure (HOF); and
logging MCG Failure Information associated with the failure event subsequent to detection of the failure event, wherein the MCG Failure Information comprises an elapsed time between time of reception of a last Radio Resource Control (RRC) reconfiguration message, including reconfiguration with sync, associated with the MCG, and time of MCG connection failure.

31. The method of claim 30, further comprising transmitting the MCG Failure Information to a base station.

32. The method of claim 30, wherein the MCG Failure Information further comprises an elapsed time between time of successful execution of the last RRC reconfiguration message, including reconfiguration with sync, associated with the MCG and time of MCG connection failure.

33. The method of claim 30, further comprising:
logging additional information in a RLF report after a fast MCG link recovery procedure, wherein the additional information indicates an outcome of the fast MCG link recovery procedure; and
transmitting the RLF report to the base station,
wherein the additional information comprises an indication of whether the wireless device was configured for fast MCG link recovery procedure at the time of the detection of the RLF event.

34. The method of claim 33, wherein the additional information comprises an indication that the wireless device performed a fast MCG link recovery procedure and the fast MCG link recovery procedure failed, optionally wherein the additional information further comprises at least one of:
cell ID of the cell in which the wireless device attempted reestablishment after T316 expiry,
an indication of whether the cell in which the wireless device attempted reestablishment after T316 expiry was in a list of Conditional Handover (CHO) candidate cells,
an elapsed time between time of the failure event in the MCG and time of reestablishment in a cell after T316 expiry, or an elapsed time between time of execution of the handover that resulted in the HOF event and time of establishment in a cell after T316 expiry,
an elapsed time between time of the failure event in the MCG and time the wireless device entering an idle mode due to no suitable cell found after T316 expiry and possible failure of reestablishment in another cell, and
an indication of T316 expiry.

35. The method of claim 33, wherein the additional information comprises an indication that the wireless device had a Conditional Handover (CHO) configuration at the time of the detection of the RLF or the HOF.

36. The method of claim 35, wherein the additional information comprises an indication that the wireless device performed a fast MCG link recovery procedure, and that the fast MCG link recovery procedure succeeded.

37. The method of claim 36, wherein the additional information further comprises at least one of:
cell ID of the cell in which the handover (HO) was executed,
an indication of whether the executed handover was in response to a received HO command or in response of a CHO configuration,
an indication of whether the executed handover was successful or not
cell ID of the cell in which the wireless device attempted reestablishment if the executed handover was not successful,
an indication that no suitable cell was found upon failure of the handover towards a target cell and possible failure of reestablishment attempt,
an elapsed time between time of the failure event in the MCG and time of the HO execution before T316 expiry, or an elapsed time between time of execution of the handover that resulted in the HOF event and time of the HO execution before T316 expiry,
an elapsed time between time of the failure event in the MCG and a point in time at which the HO execution is declared successful or completed, or an elapsed time between time of execution of the handover that resulted in the HOF event and a point in time at which the HO execution is declared successful or completed,
an elapsed time between time of the failure event in the MCG and a point in time at which the HO execution is declared unsuccessful, or an elapsed time between time of execution of the handover that resulted in the HOF event and a point in time at which the HO execution is declared unsuccessful,
an elapsed time between time of the failure event in the MCG and time of successful reestablishment after unsuccessful HO execution, or an elapsed time between time of execution of the handover that resulted in the HOF event and time of successful reestablishment after unsuccessful HO execution, and
an elapsed time between time of the failure event in the MCG and time of the wireless device entering an idle mode after unsuccessful reestablishment and unsuccessful HO execution.

38. The method of claim 33, further comprising performing at least one of:
determining that the fast MCG link recovery procedure has failed if T316 expired before the wireless device receives a handover (HO) command or if before the wireless device executes a previously configured CHO configuration; and
determining that the fast MCG link recovery procedure has succeeded if the wireless device has executed handover towards a Primary Cell (PCell), or if the wireless device received a RRC release message before T316 expiry.

39. The method of claim 33, further comprising maintaining the RLF report after handover execution.

40. A method performed by a base station for classifying mobility failure, the method comprising:
receiving, from a wireless device, Master Cell Group (MCG) Failure Information, wherein the MCG Failure Information is associated with a failure event, and the failure event is at least one of: a Radio Link Failure (RLF) and a Handover Failure (HOF); and
classifying the failure event based on the MCG Failure Information.

41. The method of claim 40, further comprising:
receiving, from the wireless device, a Radio Link Failure (RLF) report associated with the failure event; and
classifying the failure event based on the MCG Failure Information and the RLF report.

42. The method of claim 40, wherein classifying the failure event is based on:
comparison between a radio link quality at the time of the failure event of at least one of:
a source cell associated with the failure event and a target cell associated with the failure event and radio link quality of one or more neighboring cells at the time of the failure event, and
a duration in which the wireless device was dwelling or visiting at a last serving cell before the failure event.

43. The method of claim 40, wherein classifying the failure event comprises classifying the failure event as one of: too late handover, too early handover, handover to wrong cell, late conditional handover, early conditional handover, and conditional handover to wrong cell.

44. The method of claim 40, wherein the MCG Failure Information comprises an elapsed time between time of reception of a last RRC reconfiguration message associated with the MCG and time of MCG connection failure, the RRC reconfiguration message including reconfiguration with sync, and/or wherein the MCG Failure Information comprises an elapsed time between time of successful execution of the last RRC reconfiguration message associated with the MCG and time of MCG connection failure, the RRC reconfiguration message including reconfiguration with sync.

45. The method of claim 40, wherein the method comprises receiving a RLF report from the wireless device, and the method further comprising:
determining, based on the RLF report, whether the failure event was followed by a fast MCG link recovery procedure.

46. A wireless device, the wireless device comprising:
processing circuitry configured to cause the wireless device to:
detect a failure event in a Master Cell Group (MCG), wherein the failure event is at least one of a Radio Link Failure (RLF) and a Handover Failure (HOF); and
log MCG Failure Information associated with the failure event subsequent to detection of the failure event, wherein the MCG Failure Information comprises an elapsed time between time of reception of a last Radio Resource Control, RRC, reconfiguration message, including reconfiguration with sync, associated with the MCG and time of MCG connection failure; and
power supply circuitry configured to supply power to the wireless device.

47. A base station for classifying mobility failure, the base station comprising:
processing circuitry configured to cause the base station to:
receive, from a wireless device, Master Cell Group (MCG) Failure Information, wherein the MCG Failure Information is associated with a failure event, and the failure event is at least one of: a Radio Link Failure (RLF) and a Handover Failure (HOF); and
classify the failure event based on the MCG Failure Information; and
power supply circuitry configured to supply power to the base station.
